(19) United States
(12) Patent Application Publication
(10) Pub. No.: US 2010/0000834 A1
(43) Pub. Date: Jan. 7, 2010

(54) Drivetrain with a main drive shaft and drivetrain for a motor vehicle with a drive shaft extending, in particular, out of an engine block

(76) Inventors: Georg Quartier, Aachen (DE); Peter Nissen, Roetgen (DE); Tim Bartling, Aachen (DE)

Correspondence Address: COLLARD & ROE, P.C., 1077 NORTHERN BOULEVARD, ROSLYN, NY, 11576, US

(21) Appl. No.: 12/311,138

(22) PCT Filed: Sep. 20, 2007
(86) PCT No.: PCT/DE2007/001700

§ 371 Date: Mar. 19, 2009

(30) Foreign Application Priority Data
Sep. 20, 2006 (DE) 102006044828.6
Sep. 20, 2006 (DE) 102006044830.8
Feb. 7, 2007 (DE) 102007006878.8

(51) Int. Cl. F16F 15/12; F16F 15/131

(52) U.S. Cl. 192/3.28; 192/70.17

(57) ABSTRACT

In order to be able to design a connection between a drive side and a transmission side, in particular a damper side, in a drivetrain between a main driveshaft and a torsional vibration damper to be structurally stronger while at the same time having a small installation volume, the invention proposes a drivetrain with a main driveshaft and a torsional vibration damper, wherein the main driveshaft and the torsional vibration damper rotate substantially about a common rotational axis and are connected by means of a connection, wherein the connection can be released in a non-destructible fashion and/or is self-connecting, and wherein a wall is arranged axially between the driveshaft and the torsional vibration damper, which wall is sealed off against the drivetrain by means of a seal, and the drivetrain is characterized in that the connection is arranged radially further remote from the common rotational axis than the seal and than the main driveshaft.

The invention pertains to a drivetrain with a main drive shaft and a torsional vibration damper, wherein the main drive shaft and the torsional vibration damper essentially rotate about a common rotational axis and are connected to one another by means of a connection, wherein the connection can be separated in an indestructible fashion and/or is self-connecting, and wherein a wall is arranged axially between the main drive shaft and the torsional vibration damper and sealed at the drivetrain by means of a seal.

The invention also pertains to a drivetrain with a main drive shaft and with a torsional vibration damper that are connected to one another by means of a connection that can be separated in a nondestructive fashion and/or is self-connecting and rotate about a common rotational axis, and with a wall that is arranged between the main drive shaft and the torsional vibration damper and sealed at the drivetrain by means of a seal.

The invention furthermore pertains to a drivetrain for a motor vehicle with a drive shaft, with a transmission on the driven side and with a clutch arranged between the drive shaft and the transmission, as well as with a vibration damper that is arranged on the driving side of the clutch and features on the driving side a damper shaft that is functionally connected to the drive shaft by means of a semi-flexible plate.

Drivetrains of this type are realized, for example, with the torque transmitting unit described in Offenlegungsschrift DE 10 2005 025 773 A1. In this torque transmitting unit, the drivetrain comprises at least one clutch device and at least one vibration damper device between a drive unit and a transmission. The torque transmitting unit is characterized in that an input section and an output section of the vibration damper device and an input section of the clutch device are respectively arranged and supported in the radial direction on a clutch housing section of the clutch device. This makes it possible to optimize torque transmitting units of this type with respect to their installation space, wherein the drivetrain has, in particular, a simple design and can be inexpensively manufactured. In order to practically realize this structurally optimized torque transmitting unit, the present clutch device is, however, subject to stringent manufacturing requirements with respect to the connection between the crankshaft of a drive unit and, in particular, the vibration damper device such that the clutch device, particularly the aforementioned connection, needs to be intricately produced. Due to its very compact structural design, the described clutch device is furthermore subject to significant wear such that the risk of a defect of the entire torque transmitting unit is increased in the region of the clutch device.

EP 1 496 287 A1 and EP 1 496 288 A1 also disclose a drivetrain of this type, but a semi-flexible plate is provided on the driven side of a flywheel and on the driving side of a torsional vibration damper in order to be able to absorb axial vibrations.

The present invention is based on the objective of making available a drivetrain of the initially cited type that is at least no less optimized spatially, but comprises a connection with much less stringent constructive requirements between a driving side and a damper side or transmission side, respectively.

The objective of the invention is attained with a drivetrain with a main drive shaft and a torsional vibration damper, wherein the main drive shaft and the torsional vibration damper essentially rotate about a common rotational axis and are connected to one another by means of a connection, wherein the connection can be separated in an indestructible fashion and/or is self-connecting, wherein a wall is arranged axially between the main drive shaft and the torsional vibration damper and sealed at the drivetrain by means of a seal, and wherein the drivetrain is characterized in that the connection is arranged at a greater radial distance from the common rotational axis than the torsional damper wall seal and than the main drive shaft in the region of the seal.

According to the invention, the connection between the main drive shaft of the drivetrain and the torsional vibration damper of the drivetrain is arranged at a greater radial distance from the common rotational axis than, in particular, the seal of the wall between the main drive shaft and the torsional vibration damper such that vibrations of the system that are caused, in particular, by the torsional vibration damper being arranged downstream of the connection and downstream of the seal do not stress the connection as significantly because the connecting forces are also applied further radially outward.

Forces and torques in the drivetrain respectively are advantageously reduced with respect to their effect in the further outwardly positioned connection between the main drive shaft and the torsional vibration damper by the radial distance between the main drive shaft that respectively introduces the forces and torques and the connection. The connection arranged at a greater radial distance from the common rotational axis hereby is subjected to significantly lower stresses than a connection that is arranged at a lesser radial distance and provided, for example, directly on the main drive shaft or even radially within the seal. This solution furthermore makes it possible to arrange the seal such that it lies very far radially inward in order to minimize the relative speeds at this location, i.e., to relieve the seal, and to reduce the negative influences of the seal.

However, the connection may also be designed structurally larger and therefore constructively stronger than known connections between a main drive shaft and a torsional vibration damper because the inventive connection lies further radially outward and can be constructed with a larger circumference. For this reason, the present connection advantageously does not have to be realized as delicately as the connection of the known torque transmitting unit. In this context, it is also not required that the connection fulfills particularly stringent requirements with respect to the manufacturing technology in order to permanently ensure an operationally reliable connection. In other words, the connection extends around the common rotational axis with a significantly larger radius than the seal because the connection is arranged at a greater radial distance. Consequently, it is possible to design and manufacture corresponding connecting elements of the present connection that can be joined together significantly stronger and significantly larger and therefore also with less stringent tolerance requirements. On the other hand, the connecting forces lie further radially outward such that, in particular, vibrations have much less damaging effects.

In the present case, the term “connection” includes any connecting devices that are suitable for connecting a main drive shaft or components fixed on the main drive shaft, in particular, to a torsional vibration damper or to components of the torsional vibration damper by means of a friction-fitted connection, a form-fitted connection or otherwise in such a way that an intended torque can be transmitted.

The term “seal” describes any sealing devices that make it possible to seal an opening in a wall arranged between a main drive shaft and a torsional vibration damper relative to rotating components of a drivetrain, particularly the main drive shaft, that extend through the wall or are supported thereon, particularly against the escape of oil or other fluids and/or against the admission of dirt or the like. In the context of the invention, such a seal is also referred to as a wall seal.

The objective of the invention is cumulatively or alternatively also attained with a drivetrain with a main drive shaft and with a torsional vibration damper that are connected to one another by means of a connection that can be separated in a nondestructive fashion and/or is self-connecting and rotate about a common rotational axis, and with a wall that is arranged between the main drive shaft and the torsional vibration damper and sealed at the drivetrain by means of a seal, wherein the drivetrain is characterized in that the seal is arranged axially on the driving side referred to the connection.

Due to the axial arrangement of the seal on the driving side referred to the connection, it is possible to also realize the connection much stronger such that the requirements with respect to the manufacture and quality of the connection are also less stringent than those of torque transmitting units and drivetrains of this type known from the state of the art. The reason for this can be seen, in particular, in that much more installation space is provided for the connection because the seal naturally should lie on the smallest radius possible in order to wear out as little as possible and to minimize the disadvantageous influences of friction or tilting moments.

Accordingly, the objective of the invention is also attained with a drivetrain with a main drive shaft and with a torsional vibration damper that are connected to one another by means of a connection that can be separated in a nondestructive fashion and/or is self-connecting and rotate about a common rotational axis, and with a wall that is arranged between the main drive shaft and the torsional vibration damper and sealed at the drivetrain by means of a seal, wherein the drivetrain is characterized in that the seal is arranged axially on the transmission side referred to the connection.

If the seal is either arranged axially on the driving side or axially on the transmission side referred to the connection, the structure of the drivetrain is also advantageously simplified in the region of the seal such that it can be arranged on a very small radius.

It goes without saying that the advantages of a seal that is arranged axially on the driving side or axially on the transmission side referred to the connection and of a connection that is arranged further radially outward than the seal cumulate. The connection can, in principle, be structurally simplified and sufficient space remains, in particular, for the wall and the seal such that the wall can extend very far radially inward and the seal accordingly can be arranged very far radially inward.

According to one design variation, the present drivetrain features a flywheel that is rigidly arranged on the main drive shaft on the driving side of the connection. The due to the mass inertia of the flywheel, part of the disturbances that originate from a drive and move through the drivetrain can be absorbed upstream of the connection such that the connection is subjected to correspondingly lower stresses and therefore can be designed less critically.

Since flywheels usually are relatively massive and constructively realized relatively large, they can easily be structurally and constructively modified with respect to the manufacturing technology such that they form or provide at least part of the presently described connection. According to one preferred design variation that comprises a flywheel, the connection is directly produced by means of the flywheel on the driving side. The transmission of forces and/or torques from a main drive shaft to a torsional vibration damper is hereby advantageously realized because the present connection can be arranged at a greater radial distance from the common rotational axis than the seal of the wall in a constructively simple fashion on a flywheel. Furthermore, one component of the connection can be very inexpensively provided in this fashion.

It is also advantageous that the drivetrain features a connecting element that is arranged between the connection and the torsional vibration damper on the damper side of the connection and on which the present seal seals the torsional vibration damper in the region of the wall because such a connecting element makes it possible to provide a seal receptacle with a particularly simple constructive design. If the wall seal of the wall adjoins a connecting element of the connection on the damper side, for example, between an oil-free driving side and an oil-filled transmission or torsion damper side, the driving side can be separated from the damper side in the region of the connection without having to additionally disassemble the damper side for this purpose. A damper side filled with oil advantageously does not have to be emptied if the connection between the driving side and the damper side is separated because the connecting element on the damper side remains on the damper side and adjoins the wall seal in a sealing fashion at this location.

It is furthermore possible, particularly with respect to the latter-described design variation, to provide a nominal assembly surface that is designed differently from a nominal disassembly surface. In this context, the term “nominal assembly surface” describes a surface, along which the drivetrain, particularly also housing components of adjacent drivetrain regions, is joined together. In case the thusly assembled drivetrain needs to be disassembled, e.g., for maintenance or repair work, this is not realized at the nominal assembly surface, but rather at a different “nominal disassembly surface.” This even makes it possible to disassemble an oil-filled damper side from an oil-free driving side in a particularly simple fashion without having to previously remove the oil that was filled into the damper side after the assembly and is still situated at this location, wherein the transmission or the damper and the engine are joined together at a different nominal assembly surface during the assembly, during which oil is naturally not yet provided.

If the connection furthermore comprises a connecting element on the driving side that is rigidly connected to the flywheel and/or to the main drive shaft, for example a crankshaft, on the driving side and connected to the seal on the driving side of the connection, the initial assembly can be realized in a particularly simple fashion because a possibly existing oil chamber on the damper side can already be sealed prior to the assembly of the damper side by means of the seal between a wall and a connecting element on the driving side and a particularly large installation space is available. In this case, it is particularly advantageous to arrange the connection on a larger circumference than that the seal on the driven side of the seal. In one preferred embodiment, such an arrangement makes it possible, in particular, to arrange the connection in an oil chamber such that the region of the connection is relieved further due to the damping effect of the oil.

It goes without saying that the aforementioned installation advantages are also achieved, in particular, with two connections that are respectively arranged on the driving side and on the driven side of the seal, wherein one of the two connections could be realized such that it cannot be separated in a nondestructive fashion, particularly the connection arranged on the driven side of the seal.

If the drivetrain furthermore features a gear rim that is mounted radially referred to the rotational axis, particularly on the outer edge of a flywheel, it is possible to make available a compact drivetrain, in which the flywheel can mesh with the other components such as a pinion of a starter of an internal combustion engine, wherein the mass of the gear rim can simultaneously contribute to the damping of vibrations—and therefore to advantageously relieving the connection.

The objective of the invention is furthermore attained independently of the remaining characteristics of the present invention with a drivetrain for a motor vehicle with a drive shaft, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the connecting plate is connected in a nondestructively separable fashion to a rigid driving wheel radially outward on the driving side.

Such a drivetrain provides the advantage that the mass of the rigid driving wheel already forms an adequate vibration damper in a [text missing] composed of the driving wheel, the connecting plate and the damping shaft with its own and adjacent moment of inertia, wherein said vibration damper outstandingly dampens part of the vibrations that respectively occur in the damper shaft and in the connection between the connecting plate and the damper shaft due to the fact that a relatively large mass or a relatively high moment of inertia is already arranged on the primary side of the connecting plate, i.e., on the driving side of the connecting plate that forms the vibrating system to be dampened of this vibration damper arrangement. This results in an outstanding relief of the downstream components or modules, particularly if the consist, for example, of the aforementioned connections.

In the present context, the terms “semi-flexible plate” and “connecting plate” refer to plate-shaped components that transmit a torque and are realized axially softer than adjacent components transmitting a torque, particularly axially softer by an order of magnitude. In comparison with adjacent components, a “semi-flexible plate” or “connecting plate” consequently represents an almost membrane-like component that may by all means feature grooves, depressions, recesses or other structural measures, in particular, in order to axially realize this component even softer than the selected material and material thickness allow. Such components are also referred to as soft bending/swash plates.

In the initially described torque transmitting unit known from Offenlegungsschrift DE 10 2005 025 773 A1, in particular, drivetrains are disclosed, in which a semi-flexible plate is arranged on a rigid plate on the driving side and connected to the rigid plate radially outward. However, the semi-flexible plate, in turn, is connected to the drive shaft radially inward on the driving side.

In this context, DE 10 2005 025 773 A1 furthermore discloses a welded connection between the drive shaft and the damper shaft on one hand and, analogous to Offenlegungsschrift DE 102 43 279 A1, a form-fitted connection on the other hand. In both latter embodiments, measures are provided that eliminate all play from the form-fitted connection after the assembly because such a play is required for the assembly in order to radially attach the two components to one another and because the integral freedom from play is of particular importance in this respect, namely due to the fact that the connection between the drive shaft and the damper shaft is arranged on the driving side of the vibration damper and therefore subjected to extreme vibratory stresses.

In DE 10 2005 025 773 A1, the freedom from play is achieved by screwing together a cube-shaped spline connection or form-fitted connection, wherein complex auxiliary devices such as sheet metals that point radially outward and are screwed to one another need to be provided for assembly reasons. Such complicated measures appear unnecessary in the design according to DE 102 43 279 A1, in which two components with cubic toothing are mutually braced by means of a spring that, however, also turns and needs to be supported on the housing. This embodiment also has a relatively complicated design in this respect. The last arrangement furthermore minimizes the risk of rattling noises in a drivetrain of this type for a motor vehicle with justifiable constructive expenditures and justifiable assembly expenditures.

Since the connecting plate is functionally connected to a rigid driving wheel radially outward on the driving side, in particular, the connecting plate can even be separated from a drivetrain on the driving side if the driving side and the transmission side or damper side already are mutually assembled because such an outwardly arranged connection also remains relatively accessible after the assembly. This applies, in particular, to instances in which an oil chamber is provided on the transmission or damper side, wherein this oil chamber consequently can also remain closed during the dismounting of the connecting plate from the driving side.

In contrast to EP 1 496 287 A1 and EP 1 496 288 A1, which disclose a riveted connection between the disclosed semi-flexible plate and a rigid driving wheel that can only be separated by being destroyed, the ability to separate the connection between the connecting plate and the driving wheel radially outward not only makes it possible to realize adequate accessibility, but also a connection between the connecting plate and the drivetrain arranged on the driven side of the connecting plate that is inseparable or cannot be separated without being destroyed and has a simple constructive design.

Another solution proposes a drivetrain for a motor vehicle with a drive shaft, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the connection between the damper shaft and the connecting plate comprises a press-fitted connection between a connection group on the damper side and a connection group on the connecting plate side.

A press-fitted connection, which in the present context is defined in that the two interconnected connection groups are connected to one another by internal forces or tensions rather than mutual bracing with other elements such as, for example, screws, advantageously makes it possible to realize a stable connection that can be very easily manufactured and also designed sufficiently safe, particularly with respect to vibrations.

In addition, the press-fitted connection advantageously can be separated again such that the assembly work can be simplified with respect to constructive considerations. In addition to the described press-fitted connection, it would also be possible to utilize separable connections in the form of, for example, pressed spline connections, pressed conical connections or even hydraulic clamping elements that are hydraulically compressed in the radial direction. In this case, the separability is not absolutely imperative because the dismounting can be realized in combination with separable connections at a different location such that a very solid press fit can also be produced.

Yet another solution proposes a drivetrain for a motor vehicle with a drive shaft, particularly also according to one of the above-described combinations of characteristics, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the connection between the damper shaft and the connecting plate comprises an axial friction-fitted connection between a connection group on the damper side and a connection group on the connecting plate side.

In this context, the term “axial friction-fitted connection between two elements” refers to these two elements interacting with one another in the axial direction in a frictionally fitted fashion without other elements exerting connecting forces. Consequently, it is not required, in particular, to use a screw that connects the two components to one another because such a screw represents another element. The axial friction-fitted connection between the connection group on the damper side and the connection group on the connecting plate side can be very easily realized in a constructively advantageous fashion and furthermore requires very few elements.

The two components that are connected to one another by means of a press-fitted connection or the axially friction-fitted connection may also be mutually compressed by means of a conical connecting surface as long as the press-fitted connection is realized with internal forces or internal tensions, wherein the latter can only be realized if the corresponding cone angles are chosen relatively small.

In addition to the solution with the axially friction-fitted connection, another advantageous solution proposes a drivetrain for a motor vehicle with a drive shaft, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the drivetrain is characterized in that the connection between the damper shaft and the connecting plate comprises a cylindrical connecting region between a connection group on the damper side and a connection group on the connecting plate side.

For example, the cylindrical connecting region is interconnected due to the fact that the cylindrical connecting region is swelled or shrunk on the connection group on the damper side. The cylindrical connecting region may just as well be swelled or shrunk on the connection group on the connecting plate side.

A connection between the damper shaft and the connecting plate that comprises a cylindrical connecting region between the connection group on the damper side and the connection group on the connecting plate side allows a particularly simple design of the connection that ultimately can also be produced in a very simple and operationally reliable fashion, for example, in the form of a press-fitted connection, an integral connection, e.g., a welded connection, or even a screw connection or a friction-fitted connection. The cylindrical connecting region ensures, in particular, a large contact surface in the axial direction such that the connecting elements can exert correspondingly high axial connecting forces. The connection therefore can be realized in a particularly vibration-resistant fashion. This applies, in particular, in comparison with conical designs, in which a slight axial displacement can already lead to a significant reduction of the connecting surface or the contact between the connection groups.

At this point, it should be noted that the present invention is particularly suitable for dual clutch transmissions, namely if the actual torsional vibration damper should be accommodated in the housing of the transmission such that a housing leadthrough that should be arranged particularly far radially inward appears advantageous.

The objective of the invention is cumulatively or alternatively to the remaining characteristics of the invention attained with a drivetrain for a motor vehicle with a drive shaft, with a transmission on the driven side and with a clutch arranged between the drive shaft and the transmission, as well as with a torsional vibration damper that is arranged on the driving side of the clutch and features on the driving side a damper shaft that is connected to the drive shaft by means of a form-fitted connection that is effective in the second circumferential direction and comprises at least two form-fitting structures on the drive shaft side and at least two form-fitting structures on the damper shaft side, wherein one of the form-fitting structures on the driving side and one of the form-fitting structures on the damper shaft side respectively point in a first circumferential direction and the second form-fitting structure on the driving side and the second form-fitting structure on the damper shaft side respectively point in the second circumferential direction, wherein the form-fitting structure of the form-fitting structures on the driving side that points in the first circumferential direction interacts with the form-fitting structure of the form-fitting structures on the damper shaft side that points in the second circumferential direction and the form-fitting structure of the form-fitting structures on the driving side that points in the second circumferential direction interacts with the form-fitting structure of the form-fitting structures on the damper shaft side that points in the first circumferential direction, wherein the drivetrain has an operating state, in which torque is transmitted to the form-fitting structure of the form-fitting structures on the damper shaft side that points in the second circumferential direction by the form-fitting structure of the form-fitting structures on the driving side that points in the first circumferential direction and in which the form-fitting structure of the form-fitting structures on the driving side that points in the second circumferential direction is spaced apart from the form-fitting structure of the form-fitting structures on the damper shaft side that points in the first circumferential direction by a certain clearance, and wherein the drivetrain is characterized by means for generating a force that is not dependent on the angle of twist between the drive shaft and the damper shaft and counteracts a reduction of the clearance.

It is assumed that a simple assembly of the form-fitted connection can be ensured with a clearance between the structures that produce the form-fitted connection or a corresponding play or a rigid body that bridges this clearance and, if so required, can be removed for assembly purposes because a sufficient play can be provided for joining together the two components.

Drivetrains of this type known from the state of the art do not feature such means for generating a force that is not dependent on the angle of twist between the drive shaft and the damper shaft and counteracts a reduction of the clearance. For example, Offenlegungsschrift DE 10 2005 025 773 A1 discloses a welded connection between the drive shaft and the damper shaft on one hand and, analogous to Offenlegungsschrift DE 102 43 279 A1, a form-fitted connection on the other hand as already mentioned above.

With respect to constructive considerations, it appears easier to use approaches, in which a play remains in the form-fitting connection between the drive shaft and the damper shaft that is effective in the circumferential direction and both shafts are subjected to a spring force in the circumferential direction. In light of these constructive simplifications, it is almost unavoidable that the two shafts strike against one another and produce a corresponding noise during a load alternation, but this can be tolerated in light of the overall behavior of a motor vehicle during load alternations.

However, practical experience has shown that rattling noises can also occur at a constant output, wherein these rattling noises are not tolerable, particularly during quiet driving. Annoying rattling noises of this type are at least significantly minimized with an above-described drivetrain with the inventive combination of characteristics.

The advantageous means for generating a force that is not dependent on the angle of twist between the drive shaft and the damper shaft and counteracts a reduction of the clearance makes it possible, in particular, to purposefully prevent rattling noises caused by high-frequency vibrations with low amplitude. In this case, the required forces can already act accordingly, in particular, at extremely small angles of twist, wherein this is impossible with springs with a characteristic that is linearly dependent on the angle of twist.

A rigid body that is introduced into the form-fitted connection provided with a certain play and naturally no longer allows an angle of twist between the drive shaft and the damper shaft makes it possible to maintain the spacing between structures of the existing fitted connection constant. However, it would also be possible to advantageously utilize damping devices such as, for example, friction bodies or bodies that perform rolling work, wherein devices of this type usually withdraw energy from a relative movement between the drive shaft and the damper shaft by means of an energy conversion between mechanical and thermal energy. For this reason, in particular, it is advantageous that the force generating means comprise a mechanical energy converter for converting mechanical energy into thermal energy.

Consequently, a solution that was conceived independently of the remaining solutions to the objective of the invention proposes a drivetrain for a motor vehicle with a drive shaft that extends out of an engine block, with a transmission on the driven side and with a clutch that is arranged between the drive shaft and the transmission, as well as with a vibration damper that is arranged on the driving side of the clutch, wherein said vibration damper is arranged in an oil-tight housing and features on the driving side a damper shaft that is connected to the drive shaft by means of a form-fitted connection that is effective in the circumferential direction and provided with a certain play, and wherein a mechanical energy converter is provided that is effective between the drive shaft and the damper shaft and serves for converting mechanical energy into thermal energy. A mechanical energy converter of this type makes it possible to advantageously convert kinetic energy into thermal energy such that the above-described connection has very good damping properties.

According to one advantageous design variation, the mechanical energy converter is connected to the drive shaft and/or to the damper shaft by means of a form-fitted connection, wherein the former is realized, in particular, in complex energy converters. If a form-fitted connection is produced between the mechanical energy converter and other components of the drivetrain, it is precluded that any play is present in the connection between the main drive shaft on the driving side and a damper shaft, for example, of a torsional vibration damper due to the mechanical energy converter.

In one preferred design variation, the mechanical energy converter comprises a friction device. The form-fitting structures on the drive shaft side and the form-fitting structures on the damper shaft side are connected to one another without play in a constructively simple fashion by means of this friction device.

If the friction device consists of a friction ring, for example, in the form of an O-ring, the mechanical energy converter in the form of a friction device is realized in a particularly inexpensive fashion.

If the friction device, particularly the friction ring, is already compressed when the form-fitting structures on the drive shaft side and the form-fitting structures on the damper shaft side are pushed on one another, any play in the circumferential direction of the respectively opposing form-fitting structures is effectively prevented during the assembly. It is therefore advantageous if the friction device is effective in the axial direction.

If a spring element is arranged between the friction device and the drive shaft and/or the damper shaft, it is possible to forgo the frictional interaction of the aforementioned friction device, if so required.

According to another advantageous embodiment, it is proposed that the friction device comprises a flexing element. Flexing elements, in particular, make it possible to convert kinetic energy into thermal energy very well.

Particularly for this reason and in this context, it is advantageous that the mechanical energy converter comprises a flexing element.

If the flexing element is arranged between a structure on the driving side that is effective in the circumferential direction and a structure on the damper shaft side that is effective in the circumferential direction, jerks and therefore also rattling noises can be advantageously prevented or eliminated with the flexing element.

Elastic rubber elements, in particular, may be used as friction elements on one hand and as flexing elements on the other hand, wherein the latter can be realized, for example, by arranging elastic rubber regions between two structures of the form-fitted connection. It is therefore advantageous that the flexing element is realized in the form of an elastic rubber element.

It may also be advantageous that the force generating means comprise a rigid body. In this case, twisting between the drive shaft and the damper shaft is practically precluded.

The objective of the invention is furthermore attained with a drivetrain for a motor vehicle with a drive shaft that extends out of an engine block, with a transmission on the driven side and with a clutch that is arranged between the drive shaft and the transmission, as well as with a vibration damper that is arranged on the driving side of the clutch, wherein said vibration damper is arranged in an oil-tight housing and features on the driving side a damper shaft that is connected to the drive shaft by means of a friction-fitted connection that is effective in the circumferential direction, wherein the drivetrain is characterized by a rigid body in the form-fitted connection that is effective in the circumferential direction. A rigid body that is effective in the circumferential direction makes it possible to connect the drive shaft and a damper shaft to one another without play.

It is also advantageous that the rigid body has an assembly position and an installation position and that means are provided for transferring the rigid body from the assembly position into the installation position during the assembly.

The transferring means advantageously comprise a spring element. The thusly available spring force makes it possible to transfer the rigid body from the assembly position into the installation position.

A connection without play can be produced in a mechanically simple fashion if the spring element is prestressed in the assembly position and relieved for the transfer into the installation position.

The assembly of a transmission or damper side of the drivetrain and a driving side of the drivetrain can be carried out in a particularly simple fashion if the form-fitted connection is axially produced by means of devices that are rigidly connected to the housing or the engine block, respectively.

A connection that is largely free from play can also be produced if a spring element is arranged between the drive shaft and the damper shaft.

It goes without saying that clutches of different design types can be provided in the present instance. For example, the clutch may be realized in the form of a dual clutch. In another design variation, the clutch may be realized in the form of a converter clutch.

Another advantageous design variation proposes, in particular, that the vibration damper be arranged in an oil-tight housing. This makes it possible to achieve a very compact construction of the drivetrain. In addition, the oil also has a vibration-damping effect in this case.

Furthermore, the arrangement comprising a damper shaft may be advantageously utilized in connection with a drivetrain, in which the damper shaft penetrates a wall of the oil-tight housing and is connected to the drive shaft outside the housing.

Another design variation proposes that the drive shaft extends out of an engine block.

Other advantages, objectives and characteristics of the present invention are elucidated below with reference to the attached drawings that show exemplary drivetrains with differently designed connections between a driving side and a driven side of the drivetrain.

In these drawings,

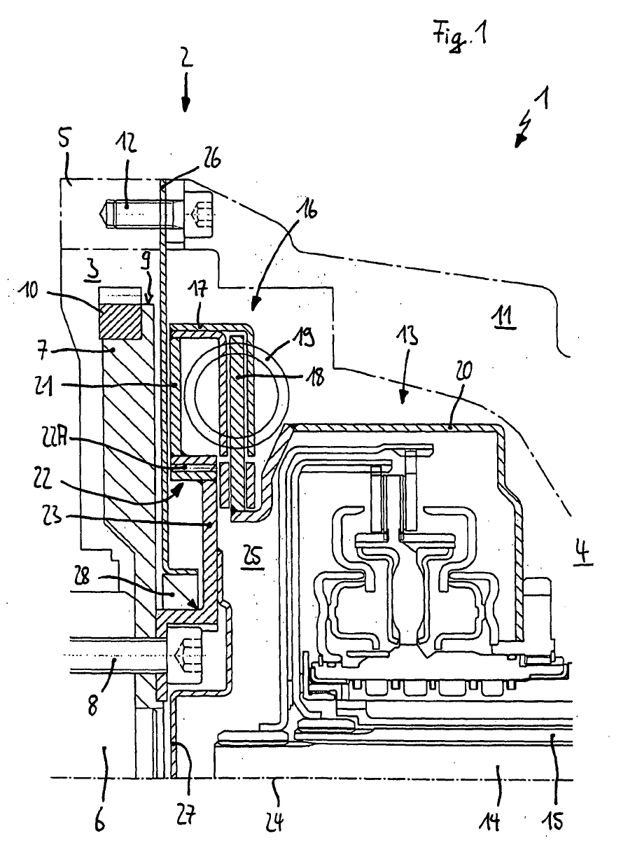

FIG. 1 schematically shows a longitudinal section through a drivetrain with a connecting device between a crankshaft of a drive and a torsional vibration damper, wherein the connecting device is arranged further radially outward than a wall seal provided on the drivetrain,

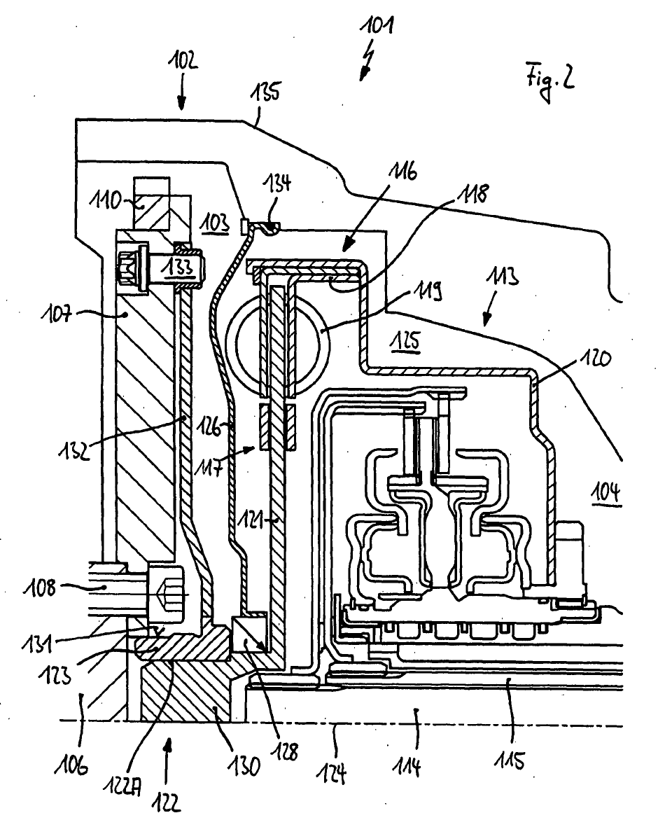

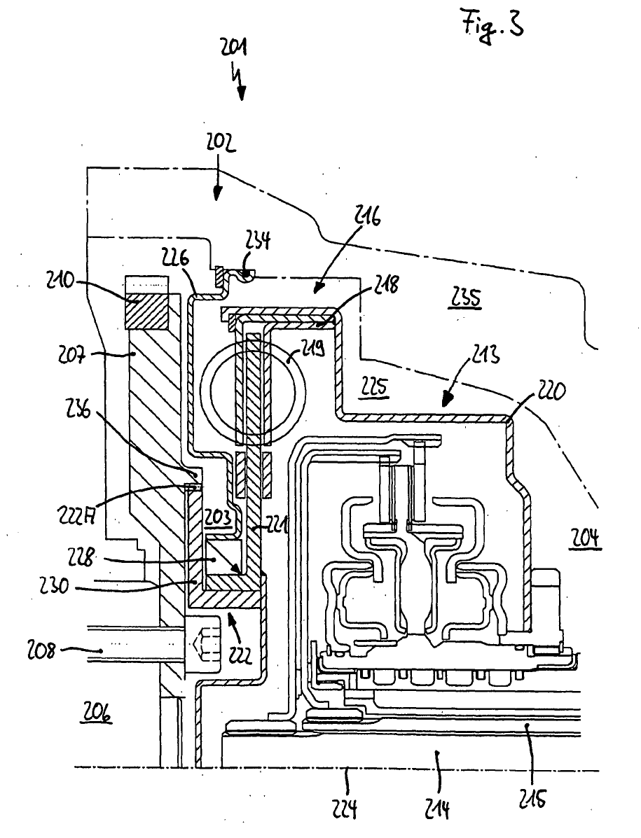

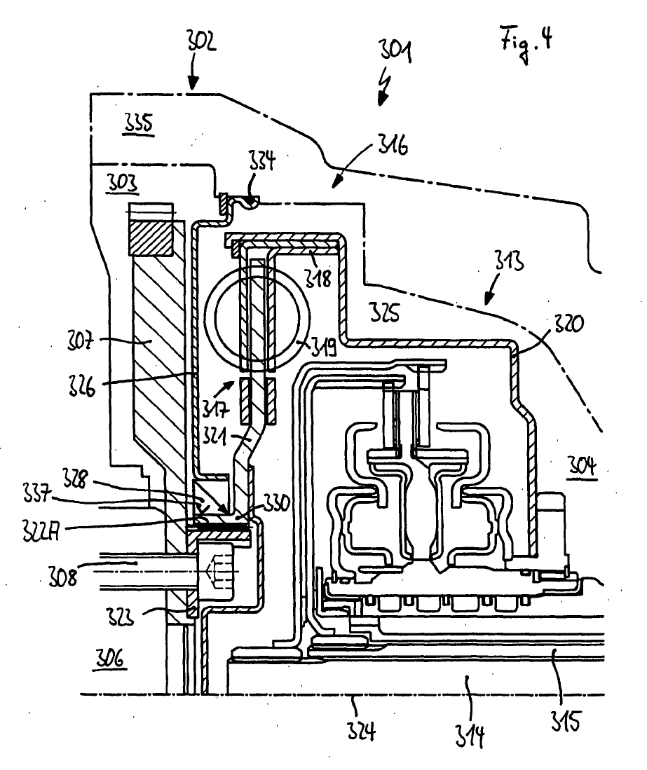

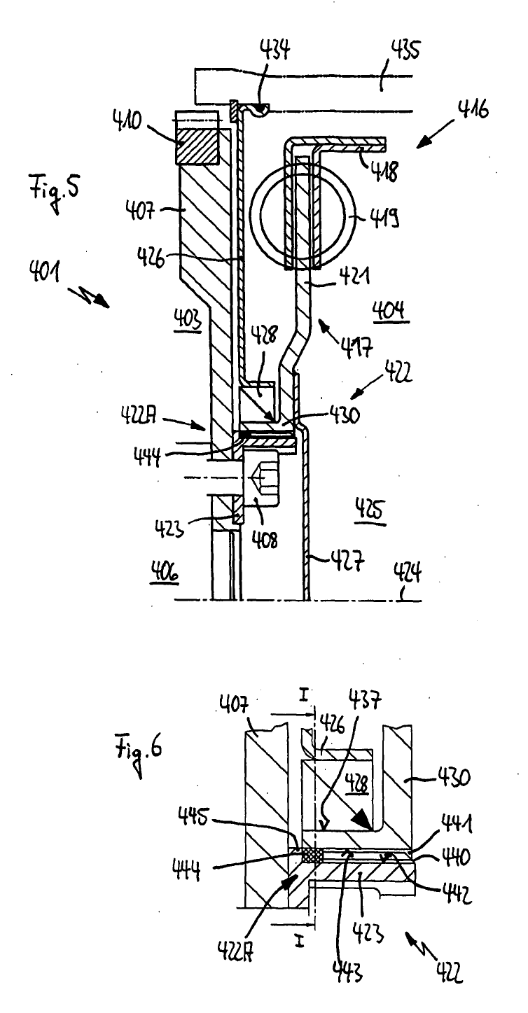

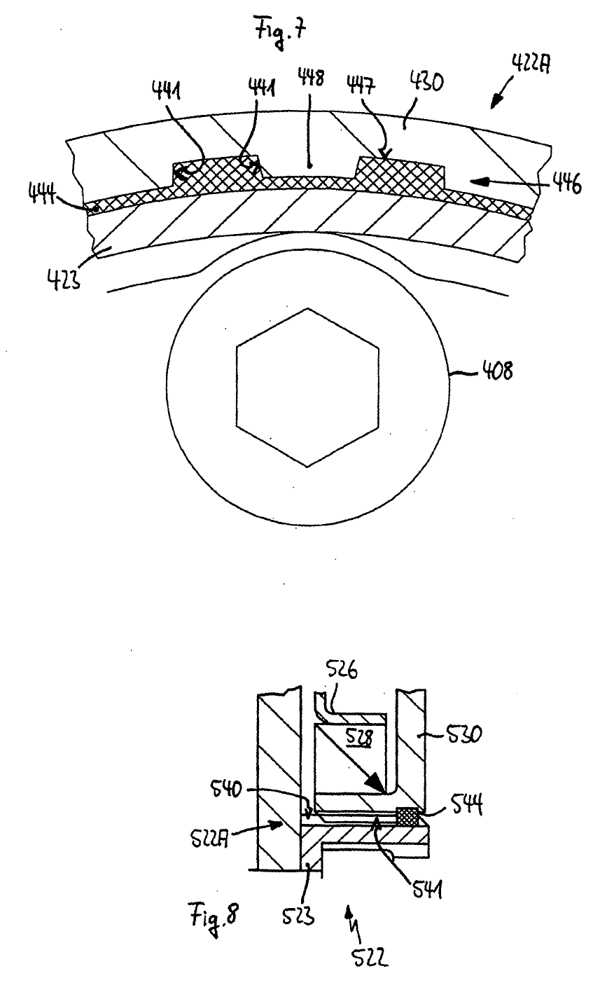

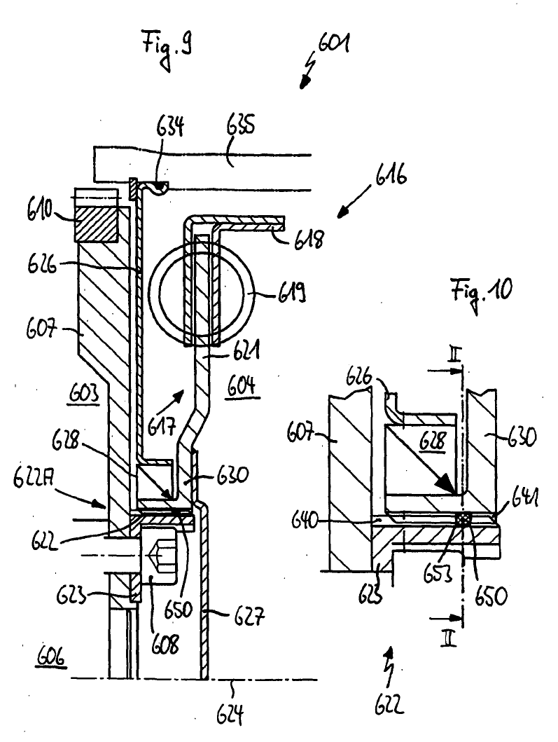

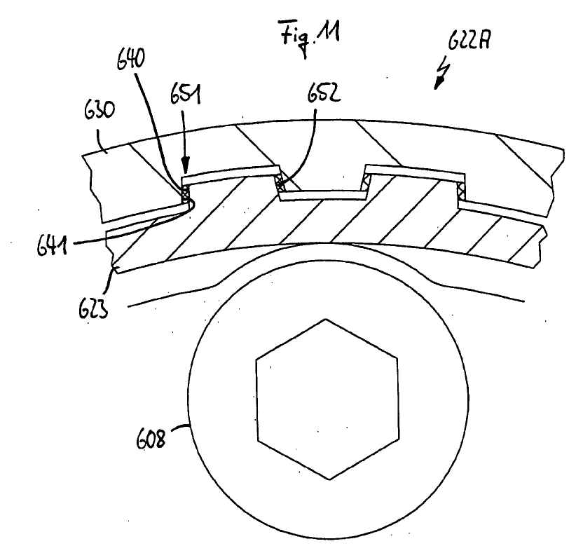

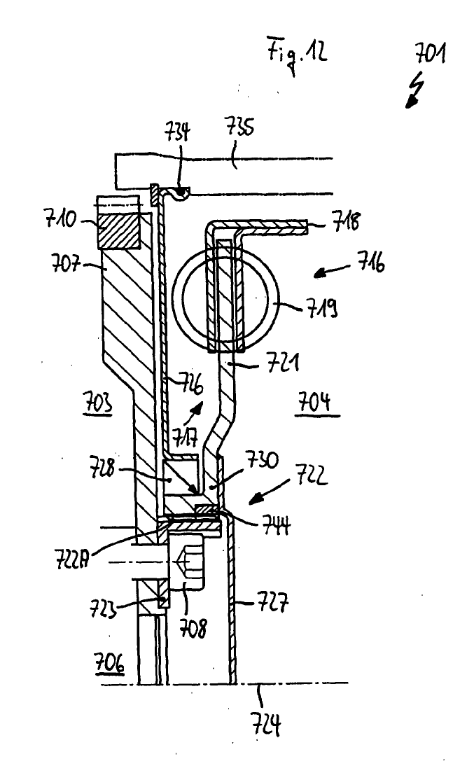

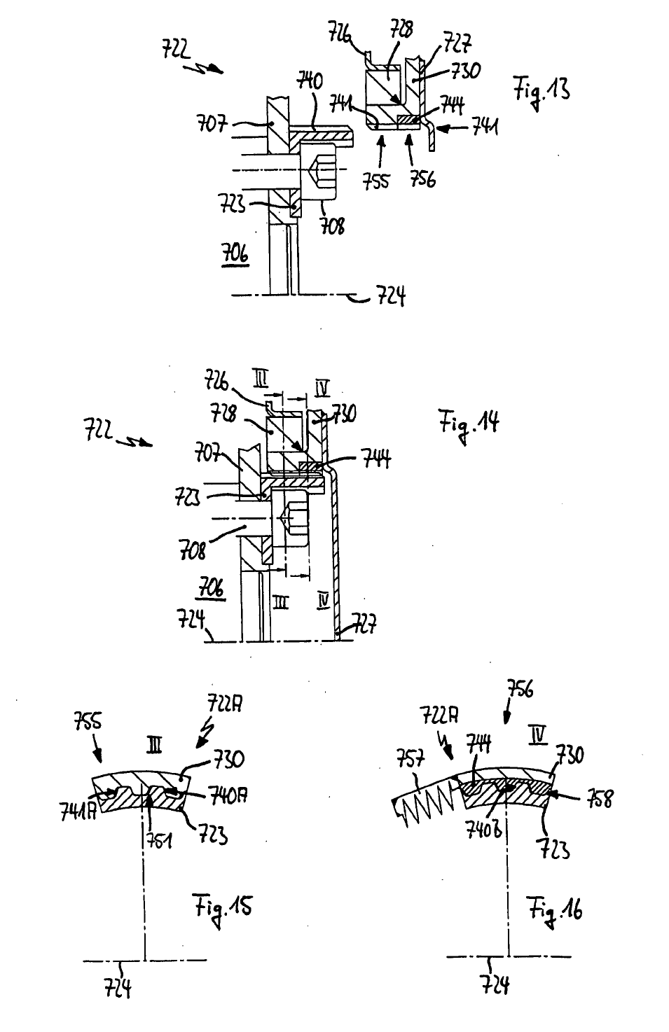

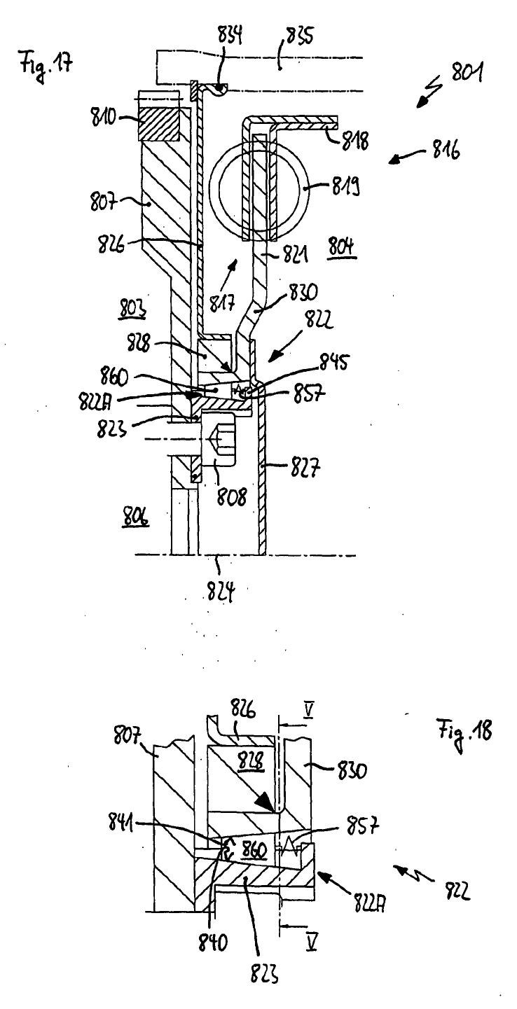

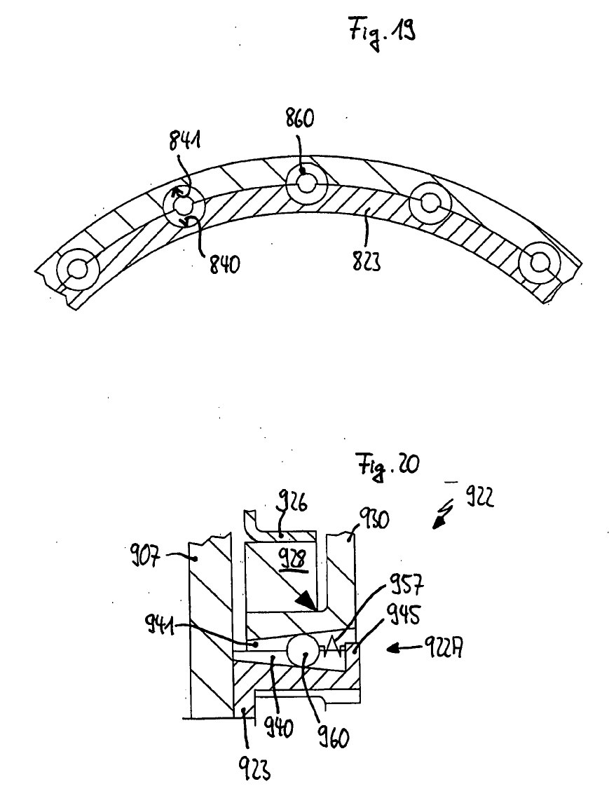

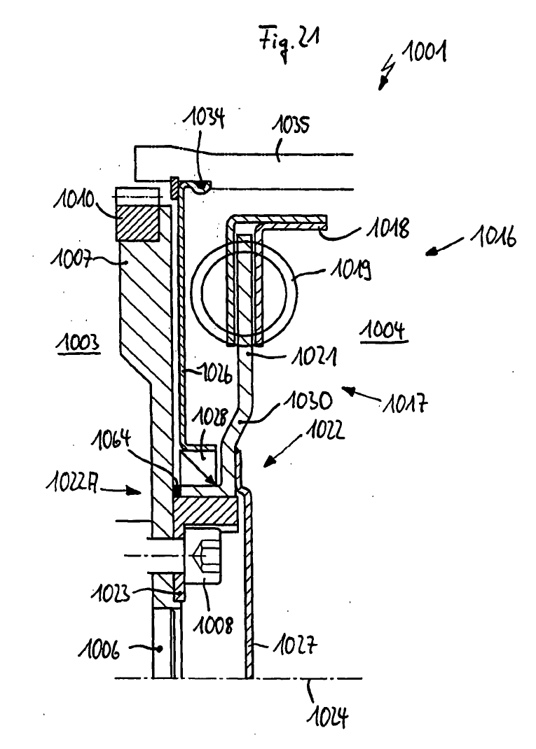

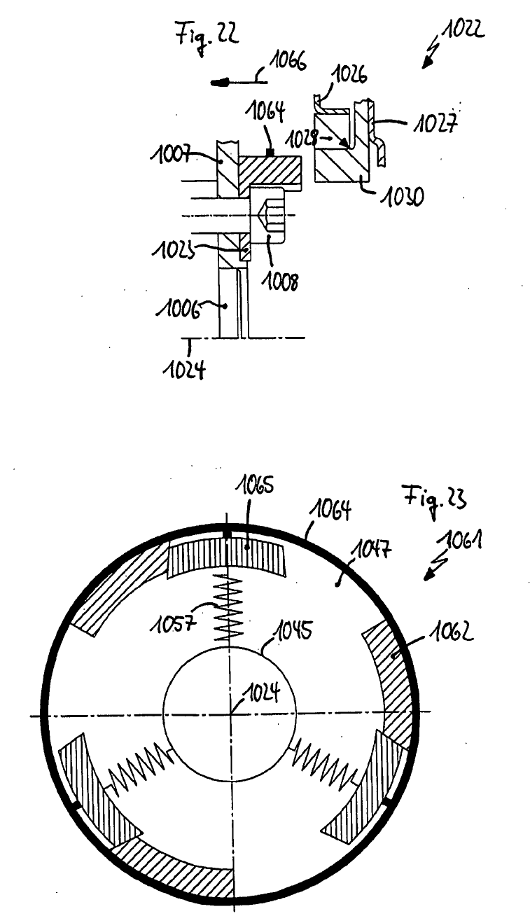

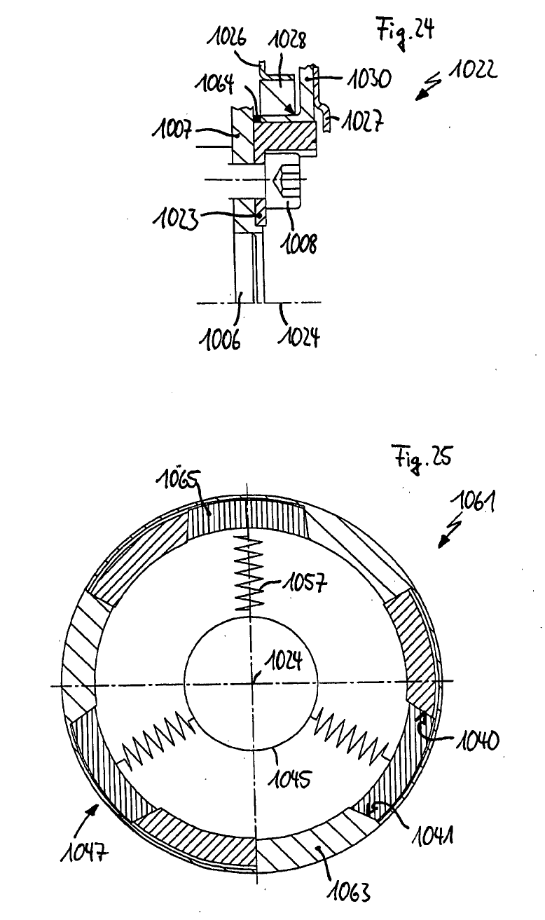

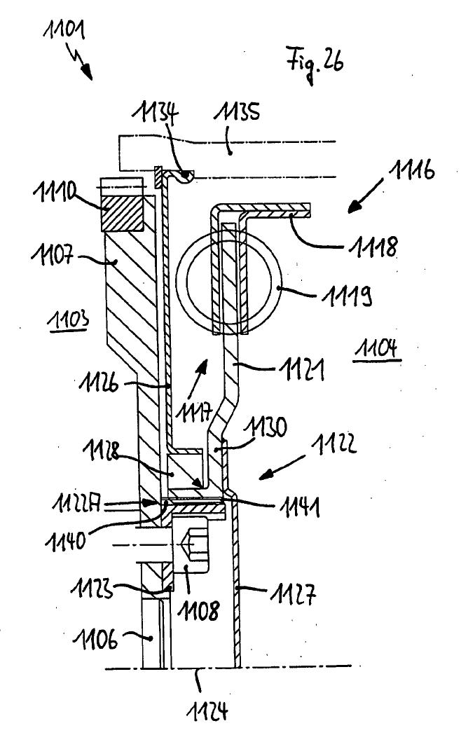

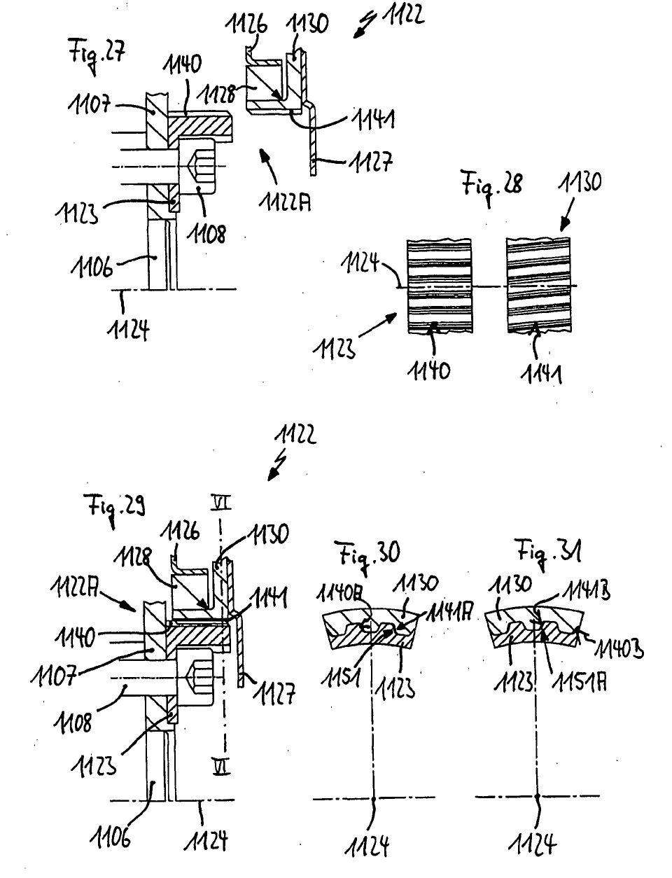

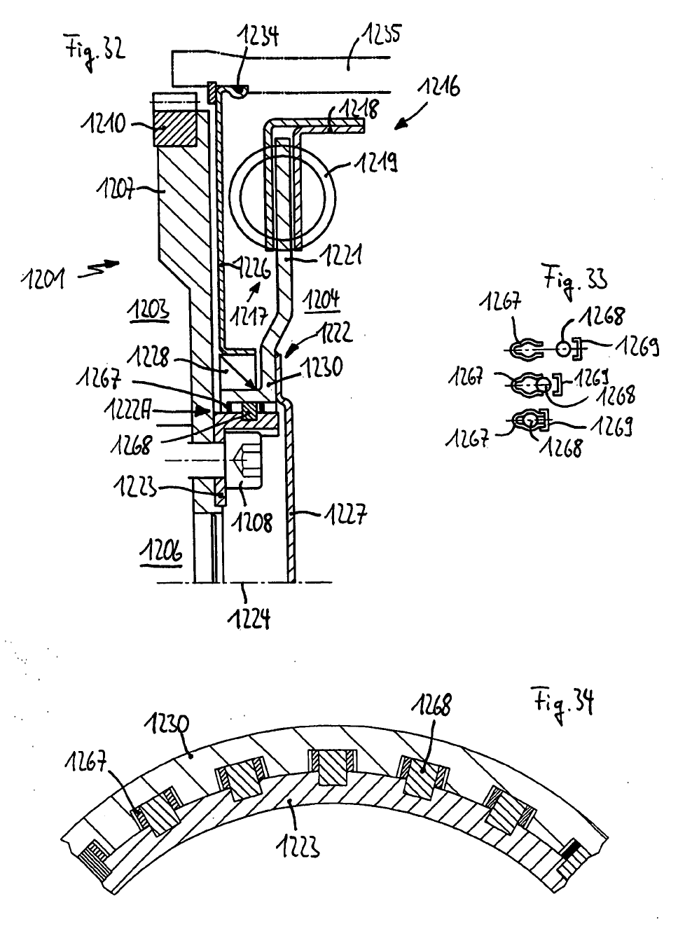

FIG. 2 schematically shows a longitudinal section through a drivetrain with a connecting device between a crankshaft of a drive and a torsional vibration damper, wherein the connecting device is arranged axially on the driving side adjacent to a wall seal provided on the drivetrain,

FIG. 3 schematically shows a longitudinal section through a drivetrain with a connecting device between a crankshaft of a drive and a torsional vibration damper, wherein the connecting device is arranged further radially outward than a wall seal provided on the drivetrain on one hand and axially on the driving side adjacent to the wall seal on the other hand,

FIG. 4 schematically shows a longitudinal section through a drivetrain with a spline connection between a connecting element on the driving side and a connecting element on the damper side,

FIG. 5 schematically shows a longitudinal section through a drivetrain with a spline connection featuring a friction ring,

FIG. 6 schematically shows a detail of the spline connection according to FIG. 5,

FIG. 7 schematically shows a section through the spline connection according to FIG. 6 along the line I-I,

FIG. 8 schematically shows a detail of another spline connection with a friction ring in an alternative position,

FIG. 9 schematically shows a longitudinal section through a drivetrain with a spline connection featuring an O-ring,

FIG. 10 schematically shows a detail of the spline connection according to FIG. 9,

FIG. 11 schematically shows a section through the spline connection according to FIGS. 9 and 10 along a line II-II,

FIG. 12 schematically shows a longitudinal section through a drivetrain with a first spline connection and a second spline connection that features a friction ring,

FIG. 13 schematically shows a detail of the two spline connections according to FIG. 12 in an assembly position,

FIG. 14 schematically shows another detail of the two spline connections according to FIGS. 12 and 13 in an operative position that corresponds to the illustration in FIG. 12,

FIG. 15 schematically shows a section through the first spline connection according to FIGS. 12 to 14 along a line III-III in FIG. 14,

FIG. 16 schematically shows a section through the second spline connection according to FIGS. 12 to 14 along a line IV-IV in FIG. 14,

FIG. 17 schematically shows a longitudinal section through a drivetrain with an alternative spline connection that comprises axially prestressed tapered roller elements,

FIG. 18 schematically shows a detail of the alternative spline connection according to FIG. 17,

FIG. 19 schematically shows a section through the alternative spline connection according to FIGS. 17 and 18 along a line V-V in FIG. 18,

FIG. 20 schematically shows a detail of a drivetrain with a spline connection that is realized similar to that shown in FIGS. 17 to 19, but features axially prestressed spherical elements,

FIG. 21 schematically shows a longitudinal section through a drivetrain with a spline connection with stationary claws and radially prestressed wedges,

FIG. 22 schematically shows a detail of the spline connection according to FIG. 21 in an assembly position,

FIG. 23 schematically shows an axial top view of the spline connection according to FIGS. 21 and 22 in an assembly position,

FIG. 24 schematically shows a detail of the spline connection according to FIGS. 21 to 23 in an operative position,

FIG. 25 schematically shows an axial top view of the spline connection according to FIGS. 21 to 24 in an operative position,

FIG. 26 schematically shows a longitudinal section through a drivetrain with an inseparable spline connection with tooth flanks that are angularly aligned relative to one another,

FIG. 27 schematically shows a detail of the spline connection according to FIG. 26 in an assembly position,

FIG. 28 schematically shows a view of two tooth flanks of the spline connection according to FIGS. 26 and 27 that can be engaged with one another and are angularly aligned relative to one another,

FIG. 29 schematically shows a detail of the spline connection according to FIGS. 26 to 28 in an operative position,

FIG. 30 schematically shows a section through the spline connection according to FIGS. 26 to 29 on the driving side along the line VI-VI, namely in the operative position according to FIG. 29,

FIG. 31 schematically shows a section through the spline connection according to FIGS. 26 to 30 on the driving side along the line VI-VI, namely in the operative position according to FIG. 29,

FIG. 32 schematically shows a view of a drivetrain with an inseparable spline connection with spring clips,

FIG. 33 schematically shows a view of a spring clip during the transfer of the spline connection according to FIG. 32 from an assembly position into an operative position, and

FIG. 34 schematically shows a cross section through the spline connection according to FIGS. 32 and 33 in an operative position.

The drivetrain 1 shown in FIG. 1, particularly for a (not-shown) motor vehicle, represents a transition area 2 between a driving side 3 and a transmission side 4 of the drivetrain 1. In this case, a primary housing 5 and a crankshaft 6 that forms the main drive shaft of the drivetrain 1 and to which a flywheel 7 is flanged by means of a screw arrangement 8 are situated on the driving side. On its outer circumference 9, the flywheel 7 features a gear rim 10 that can mesh with the gear wheels of a starter. The starter and related elements such as, e.g., the gear wheels of the starter are not illustrated in this figure in order to provide a better overview.

A secondary housing part 11 that is screwed to the primary housing part 5 by means of a housing screw arrangement 12 is essentially situated on the transmission side. In addition, a dual clutch 13 that is supported on a clutch output shaft 14 and on a clutch output sleeve 15 and a torsional vibration damper 16 with a damper input side 17, on which forces or torques can be introduced into the torsional vibration damper 16, and with a damper output side 18, on which the forces or torques introduced into the torsional vibration damper 16 can be transmitted to the dual clutch 13, are also situated on the transmission side. The torsional vibration damper 16 contains other components in the form of torsional vibration damper springs 19 that at least reduce undesirable vibrations, in particular, between the damper input side 17 and the damper output side 18 to an uncritical level in cooperation with damping devices that are not illustrated in detail in this figure and may consist, for example, of oil or any friction elements.

The torsional vibration damper 16 and the dual clutch 13 are connected by means of a driven torsional vibration damper section 20 that makes it possible to transmit forces or torques from the torsional vibration damper output side 18 into the dual clutch 13.

Dual clutches 13 are sufficiently known from the state of the art such that the design of the present dual clutch 13 is not discussed further.

The torsional vibration damper 16 furthermore features a driving torsional vibration damper section 21 that is fixed on the crankshaft 6 with the aid of a connecting device that comprises a self-connecting and indestructibly separable connection 22A, particularly a connecting element 23 of the connecting device 22 on the driving side, and the screw arrangement 8. The flywheel 7 is flanged to the crankshaft 6 by means of the screw arrangement 8 in a rigid but separable fashion.

The described components of the drivetrain 1 that essentially consists of the crankshaft 6, the flywheel 7, the torsional vibration damper 16, the dual clutch 13, the clutch output shaft 14 and the clutch output sleeve 15 rotate about a common rotational axis 24 within the housing parts 5 and 11.

Since the clutch in the present embodiment consists of an oil-lubricated dual clutch 13 and the torsional vibration damper 16 and the dual clutch 13 are jointly arranged in an oil chamber 25, a stationary housing wall 26 on one hand and a housing wall 27 that rotates with the drivetrain 1 are provided between the transmission side 4 and the driving side 3 for the purpose of separating the two sides 3 and 4, wherein a spatial and oil-tight separation between the driving side 3 and the transmission side 4 is realized by means of the aforementioned housing walls.

In order to seal the stationary housing wall 26 relative to the components of the drivetrain 1 that rotate about the common rotational axis 24 in an operationally reliable fashion, a wall seal 28 is positioned between the connecting element 23 of the connecting device 22 on the driving side and the stationary housing wall 26 in this exemplary embodiment such that the oil chamber 25 provided on the transmission side is spatially separated from the driving side 3. It is hereby prevented that oil from the transmission side 4 is admitted into the oil-free region of the driving side 3.

In this exemplary embodiment, the connection 22A of the connecting device 22 is arranged at a greater radial distance from the common rotational axis 24 than the wall seal 28 between the stationary housing wall 26 and the connecting element 23 on the driving side and than the crankshaft 6.

The connection 22A is realized in the form of a spline connection, in which form-fitting structures of the connecting element 23 on the driving side and form-fitting structures of the torsional vibration damper 21 on the driven side are pushed into one another and mutually clamped. Since the connection 22A is arranged further radially outward than the wall seal 28 and the crankshaft 6, the connection 22A is relieved more significantly from the forces or torques occurring in the drivetrain 1 than in an arrangement, in which the connection 22A is arranged, for example, directly on the crankshaft 6 or at least closer to the crankshaft 6 than the wall seal 28 is arranged relative to the crankshaft 6.

This advantageously makes it possible to provide the connection 22A with simple teeth or another constructively uncomplicated plug connection.

This furthermore makes it possible, in particular, to realize the connection 22A in the form of a spline connection or a form-fitted connection with simple flanks. In this first exemplary embodiment, the form-fitted connection is produced, in particular, axially by means of a device that is rigidly fixed on the housing or the engine block such as the present housing screw arrangement 12.

In addition to reducing the forces or torques to be transmitted at the connection 22A that lies further radially outward, natural vibrations of the drivetrain 1 also affect the connection 22A much less than in an arrangement, in which this connection 22A would be positioned closer to the crankshaft 6.

Due to the broad spatial separation between the connection 22A and the seal 28 in association with the fact that the connection 22A lies further radially outward than the wall seal 28, the connection 22A of the connecting device 22 can furthermore be structurally designed significantly stronger due to the available installation space than in another construction, in which the connection 22A is arranged between the seal 28 and the common rotational axis 24.

Above all, another advantage with respect to the wall seal 28 that lies further radially inward is achieved in this case, namely that it is possible to use a wall seal 28 with a smaller circumference than in instances, in which the connection 22A would have to be arranged between the common rotational axis 24 and the seal 28. This advantageously reduces the surfaces to be sealed in the region of the wall seal in the present embodiment.

The present connection 22A of the connecting device 22 can be advantageously separated in a nondestructive fashion such that the driving side 3 can be removed from the transmission side 4 without any difficulty and the two sides 3 and 4 subsequently can be once again quickly joined together without any difficulty, for example, after maintenance or repair work has been performed.

The drivetrain 101 shown in FIG. 2 comprises on its driving side 103 a crankshaft 106, to which a flywheel 107 is flanged by means of a screw arrangement 108. The flywheel 107 also comprises a gear rim 110 in this exemplary embodiment.

A dual clutch 113 that is supported on a clutch output shaft 114 and on a clutch output sleeve 115 is situated on a transmission side 104 of the drivetrain 101. In addition, a torsional vibration damper 116 is provided on the transmission side.

The damper output side 118 of the torsional vibration damper 116 is functionally connected to components of the dual clutch 113 by means of a driven torsional damper section 120 in this case. On its torsional vibration damper input side 117, the torsional vibration damper 116 features a driving torsional vibration damper section 121 that corresponds with the torsional vibration damper output side 118 by means of torsional vibration damper springs 119.

In this case, the driving torsional vibration damper section 121 and a connecting element 130 of the present connecting device 122 on the damper side are realized in one piece. The connecting device 122 is arranged in a transition area 122 between the driving side 103 and the transmission side 104.

The connecting element 130 on the damper side is connected to a connecting element 123 of the connecting device 122 on the driving side in a force-fitted or torque-fitted fashion by means of a connection 122A of the connecting device 122. The connecting element 123 on the driving side is already pre-centered on the flywheel 107 with a centering surface 131. The arrangement of a centering surface 131 on a connecting device 122, particularly on the connecting element 123 on the driving side, is also advantageous without the remaining characteristics of the present invention because it significantly simplifies the connection between a driving side and a transmission or damper side 104 of the drivetrain 101. It would be possible, in particular, to loosely connect the driving side 103 and the transmission side 104 to one another such that an installation and removal is significantly simplified.

On the other hand, the connecting element 123 on the driving side is connected to a connecting plate 132 that is braced on the flywheel 107 by means of a sleeve-screw arrangement 133. The connecting element 123 on the driving side is rigidly but separably fixed on the flywheel 107 in this fashion.

In addition, the connecting plate 132 is advantageously provided on the flywheel 107 on the damper side such that vibrations that are caused or amplified by its mass can be directly dampened by means of the torsional vibration damper 116 without disadvantageously stressing the drivetrain 101 to a critical level. This is possible because the connecting plate 132 is arranged in the drivetrain 101 closer to the torsional vibration damper 116 than it was usually the case until now in the state of the art. Since the connecting plate 132 is fixed on the flywheel 107 by means of the sleeve-screw arrangement 133 that lies further radially outward, the masses of the flywheel 107 and the mass of the connecting plate 132 already form an adequate first vibration damper that outstandingly dampens a large part of the vibrations occurring in the connection 122A between the connecting element 123 on the driving side and the connecting element 130 on the damper side due to the fact that a relatively large mass or a relatively high moment of inertia is already arranged on the driving side of the connecting plate.

On the other hand, it is advantageous to center a connecting plate 132, for example, on a flywheel or a crankshaft regardless of the fact whether or not the connecting plate 132 is connected to a connecting device 122.

This means that the movable components of the drivetrain 101, namely the crankshaft 106, the flywheel 107, the connecting plate 132, the connecting device 122, the torsional vibration damper 116, the dual clutch 113, the clutch output shaft 114 and the clutch output sleeve 115, are supported such that they are rotatable about a common rotational axis 124.

Since an oil chamber 125 on the transmission side needs to be realized spatially separate from an oil-free region of the driving side 103, a stationary housing wall 126 is provided in the transition area 102. The stationery housing wall 126 is sealed relative to a transmission housing 135 on one hand by means of an O-ring seal 134 and relative to the connecting element 130 on the damper side on the other hand by means of a wall seal 128. The O-ring seal 134 primarily forms an outer wall seal while the wall seal 128 forms an inner wall seal that is arranged in the drivetrain 101 on the torsion damper side in the sense of the present invention.

In order to arrange the connection 122A of the connecting device 122 at a greater distance from the wall seal 128 and to thusly make it possible to structurally design the connection stronger, the connection 122A is arranged axially on the driving side referred to the seal 128 in this exemplary embodiment and the seal 128 is arranged axially on the transmission side referred to the connection 122A, respectively.

Due to the sleeve-screw arrangement 133 between the flywheel 107 and the connecting plate 132 that is arranged further radially outward, the connection 122A is subjected to reduced vibrations by the connecting element 123 on the driving side because the flywheel 107 already forms an adequate first vibration damper in association with the connecting plate 123 as mentioned above. The connection 122A naturally also is only subjected to insignificant vibrations by the connecting element 130 on the damper side because the connecting element 130 provided on the damper side is integrally connected to the driving torsional vibration damper section 121 of the torsional vibration damper 116.

The connection 122A that is thusly subjected to reduced stresses therefore can be advantageously designed in the form of a simple spline connection, e.g., in the form of a serrated shaft, wherein the corresponding connecting surfaces of the connecting element 123 on the driving side and the connecting element 130 on the damper side are realized conically in this exemplary embodiment. This results in a plug connection with a particularly simple design of the connection 122A, wherein the transmission side 104 is simply inserted into the connecting element 123 on the driving side that is advantageously pre-centered on the flywheel 107 by means of the centering surface 131 and screwed to the flywheel 107 by means of the connecting plate 132 and the sleeve-screw arrangement 133 with its connecting element 130 on the damper side. Due to the attachment of the connecting elements 123, 130 that have a conical design in the region of the connection 122A, a constructively simple press-fitted connection with an axial friction fit is realized between a connection group on the connecting plate side and a connection group on the damper side. In an alternative embodiment, a spline connection with cylindrical diameter and parallel flanks may be provided that is produced by means of a press-fitted connection. This makes it possible to very effectively prevent any play and to very precisely position the connecting element 123 axially on the connecting element 130. Alternatively, it would just as well be possible to choose a connection with smooth conical or cylindrical surfaces as long as, in particular, the expected moments allow such a connection.

For example, a serrated shaft has the advantage that a hub corresponding thereto can be designed in a relatively thin-walled fashion. However, it is still able to transmit high torques. The centering surface 131 of the connecting element 123 on the driving side may be advantageously realized with a smaller diameter referred to its outer circumference. This in turn makes it possible to design the outer circumference of the centering surface 131 smaller than the outer circumference of the crankshaft 106 such that the centering surface 131 can be positioned within the crankshaft diameter. This allows an altogether very compact design of the drivetrain 101. On the other hand, it goes without saying that it would also be possible to forgo this type of centering in this exemplary embodiment.

In this construction, in particular, it is possible to provide a nominal assembly surface between the driving side 103 and the driven side 104 that differs from a nominal disassembly surface between the driving side 103 and the transmission side 104 because the driving side 103 and the transmission side 104 are not separated from one another in the region of the connection 122A in order to disassemble the drivetrain, but rather in the region of the sleeve-screw arrangement 133. For this purpose, the sleeve-screw arrangement 133 is loosened such that the connecting plate 132 can be removed from the flywheel 107 together with the transmission side 104.

Particularly the disassembly is hereby significantly simplified because the sleeve-screw arrangement 133 is well accessible in the assembled state of the connection 122A. On the other hand, it goes without saying that such an assembly and disassembly rule does not necessarily have to observed and that, for example, the connection 122 could also be produced first during the assembly before the connecting plate 132 is fixed on the flywheel 107.

Furthermore, the exemplary embodiment according to FIG. 2 provides the advantage, particularly also in comparison with the exemplary embodiment according to FIG. 1, that the driving side 103 and the transmission side 104 can be removed without having to drain an oil stored in an oil chamber 125 on the transmission side, namely because the housing wall 126 does not even have to be opened in the transition area 102 during the disassembly. With respect to the other exemplary embodiments described, this could also be achieved independently of the arrangements of the respectively described connections if a connecting plate 132 similar to that used in the exemplary embodiment according to FIG. 2 would also be provided in these exemplary embodiments.

At this point, it should be noted that the characteristics with respect to the described connecting plate 132 are also advantageous independently of the remaining characteristics of the present invention because they make it possible to additionally develop drivetrains known so far, particularly with respect to their disassembly options.

The drivetrain 201 shown in FIG. 3 features a connecting device 222 with a connection 222A in a transition area 202 between a driving side 203 and a transmission side 204 of the drivetrain 201, wherein said connection is arranged further radially outward than a wall seal 228 provided in this case on one hand and axially on the driving side adjacent to the wall seal 128 on the other hand.

The connection 222A is arranged directly between a flywheel web 236 of a flywheel 207 and a connecting element 230 of the connecting device 222 on the damper side. The connection 222A is hereby directly connected to the flywheel 207 on the driving side such that it is advantageously possible to forgo an additional connecting element on the driving side (see FIGS. 2 and 3, reference symbols 23 and 123).

The wall seal 228 is supported directly on the driving torsional vibration damper section 221 on one hand and on a stationary housing wall 226 on the other hand in this case. The stationary housing wall 226 is sealed relative to a transmission housing 235 by means of an O-ring seal 234 such that an oil chamber 225, in which the torsional vibration damper 116 and a dual clutch 213 are positioned, is permanently sealed relative to the oil-free driving side 203 in an operationally reliable fashion.

The torsional vibration damper 216 and the dual clutch 213 are connected by means of a driven torsional vibration damper section 220 that is fixed on an outer side 218 of the torsional vibration damper. The driven torsional vibration damper section 220 is connected to the driving torsional vibration damper section 221 in a springable and therefore vibration-reducing fashion by means of torsional vibration damper springs 219.

The flywheel 207 also comprises a gear rim 210 and is screwed to a crankshaft 206 of the driving side 203 by means of a screw arrangement 208.

The design of the present dual clutch 213 is only discussed to the extent that this clutch is supported on a clutch output shaft 214 and on a clutch output sleeve 215. In this case, all movable components of the drivetrain 201 are supported such that they are rotatable about a common rotational axis 224.

Since the connection 222A is also arranged further radially outward than the wall seal 228 and further radially outward than the crankshaft 206 in this exemplary embodiment, all above-described advantages with respect to a connection that is arranged this far radially outward also apply to the drivetrain 201. In this case, it is also possible, in particular, to realize the connection 222A in the form of a simply designed spline connection.

Simply designed spline connections of this type are known from the state of the art and not discussed in greater detail in the present application because they are sufficiently known, for example, in the form of a multitooth shaft connection.

This simply designed spline connection can also be separated in a relatively simple fashion by axially moving apart the driving side 203 and the transmission side 204 along the common rotational axis 224. This in turn makes it possible to separate the driving side 203 from the transmission side 204 without having to drain oil from the oil chamber 225. On the contrary, it is possible to separate the entire driving side 203, particularly the crankshaft 206 with the flywheel 207 fixed thereon, from the transmission side 204 in the region of the connection 222A.

Similar advantages are attained with the connection 322A of a drivetrain 301 that is illustrated in an exemplary fashion in FIG. 4, wherein the connection 322A is realized in the form of a simple spline connection between a connecting element 323 on the driving side that is screwed to the face of a crankshaft 306 in the form of an attachment by means of a screw arrangement 308, and a connecting element 330 on the driven side that is integrally connected to a driving torsional vibration damper section 321 of a torsional vibration damper 326. The connecting element 323 on the driving side is arranged in the form of an attachment between the screw arrangement 308 and a flywheel 307 that is also fixed on the face of the crankshaft 306 with the screw arrangement 308.

In addition to its driving torsional vibration damper section 321, the torsional vibration damper 316 also comprises a driven torsional vibration damper section 320 that is fixed on a torsional vibration damper output side 318. The torsional vibration damper output side 318 is connected to a torsional vibration damper input side 317 that essentially comprises the driving torsional vibration damper section 321 by means of torsional vibration damper springs 319. The driven torsional vibration damper section 320 is connected to a dual clutch 313 that is supported on a clutch output shaft 314 on one hand and on a clutch output sleeve 315 on the other hand.

The spline connection 322A makes it possible to separate a driving side 303 of the drivetrain 301 from a transmission side 304 of the drivetrain 301 and to axially move the driving side and the transmission side apart along a common rotational axis 324 for this purpose without having to previously open an oil chamber 325 provided on the transmission side and draining the oil contained therein. An unnumbered cover plate is also arranged on the driven torsional vibration damper section 321 for this purpose. It goes without saying that such a cover plate that is provided on a component with a sealing effect is also correspondingly advantageous independently of the remaining characteristics of the present invention because such a component can be constructed lighter and therefore more cost-efficient.

Due to the fact that the connection 322A, particularly a connecting element 330 on the damper side, is also in direct contact with the torsional vibration damper 316, the connection 322A is only subjected to insignificant or ideally almost none of the vibratory stresses occurring in the drivetrain 301.

Another constructive simplification is achieved in this case with respect to a wall seal 328 that is provided between a stationary housing wall 326 and rotating components of the drivetrain 301 because a corresponding seal contact surface is provided directly on the smallest outside surface circumference 337 of the connecting element 330 on the damper side and the wall seal 328 therefore adjoins the connecting element 330 on the damper side. The corresponding sealing surface is formed by the smallest outside surface circumference 337.

The stationary transmission wall 326 is sealed relative to a transmission housing 335 by means of an O-ring seal 334.

In the drivetrain 401 shown in FIGS. 5 to 7, an engine side 403 and a transmission side 404 are essentially connected to one another by means of a connection 422A that is realized in the form of a spline connection.

The spline connection 422A is realized with form-fitting structures 440 (see FIG. 6) on the driving side on one hand and with form-fitting structures 441 (see FIGS. 6 and 7) on the damper side on the other hand. The form-fitting structures 441 on the driving side are arranged on a connecting element 423 on the driving side that is screwed to a crankshaft 406 together with a flywheel 407 by means of a screw arrangement 408.

The form-fitting structures 441 on the damper side are accordingly arranged on a connecting element 430 on the damper side that is realized integrally with a driving torsional vibration damper section 421 of the torsional vibration damper 416. The driving torsional vibration damper section 421 is connected to a torsional vibration damper output side 418 by means of torsional vibration damper springs 419.

The form-fitting structures 440 on the driving side are processed on an outside surface 442 of the connecting element 423 on the driving side while the form-fitting structures 441 on the damper side are processed on an inner side 443 of the connecting element 430 on the damper side. The connection 422A consists of a simply designed spline connection, in which an assembly clearance is provided between the form-fitting structures 440 on the driving side and the form-fitting structures 441 on the damper side. This is the reason why the connection 422A also features a friction ring 444 that is clamped in the region of a shoulder 445 of the connecting element 423 on the driving side, namely between this connecting element and the form-fitting structures 440 on the driving side. The friction ring 444 makes it possible to produce a connection 422A without play between the connecting element 423 on the driving side and the connecting element 430 on the driven side such that undesirable rattling noises, as well as component damages due to the assembly clearance, are advantageously prevented. In this case, the friction ring 444 represents a force generating means that generates a force for counteracting a rotation of the connection groups on the driving side and the damper side. The friction device in the form of a friction ring 444 simultaneously forms a mechanical energy converter for converting mechanical energy into thermal energy. A rubber-elastic flexing element is hereby realized in a constructively simple fashion. Due to its elastic properties, a spring element in the form of the flexing element therefore is also arranged between the “drive shaft” in the form of the crankshaft 406 and a “damper shaft” in the form of the connecting element 430 on the damper side.

In order to completely eliminate the assembly clearance, the friction ring 444 in this exemplary embodiment cumulatively comprises wedge-shaped elevations 446 that engage without play into the intermediate spaces 447 of the teeth 448 that form the form-fitting structures 441 on the damper side. A simple spline connection 422A is hereby permanently designed without play such that damaging play-related jerks or percussions in the drivetrain 401 are prevented on the form-fitting structures 440 on the driving side, as well as on the form-fitting structures 441 on the damper side. Due to the simple but effective construction of the connection 422A, the driving side 403 and the transmission side 404 can furthermore be easily assembled in the region of the connection 422A and disassembled again as long as no assembly surface and no disassembly surface is provided as mentioned with reference to other exemplary embodiments.

Furthermore, a wall seal 428 is provided on the smallest outside surface circumference 437 of the connecting element 430 on the damper side, wherein said wall seal seals a stationary housing wall 426 of an oil chamber 425 that is at least partially filled with oil relative to rotating components of the drivetrain 401 such that components relevant to the seal can have a simple design and their number can be reduced.

In the connecting device 522 shown in FIG. 8, the actual connection 522A is realized similar to the connection 422A of the drivetrain 401 shown in FIGS. 5 to 7. The connection 522A is also realized in the form of a simple spline connection with form-fitting structures 540 on the driving side and form-fitting structures 541 on the damper side. The form-fitting structure 540 on the driving side is provided on a connecting element 523 on the driving side, and the form-fitting structure 541 on the damper side is accordingly provided on a connecting element 530 on the damper side. Since the spline connection is realized with a certain play that, however, is undesirable during the operation, the connection 522A additionally comprises a friction ring 544 with wedge-shaped elevations (not illustrated in this figure; see FIG. 7) that are attached to the connecting element 530 on the damper side with corresponding intermediate spaces (not shown in this figure; see FIG. 7). An oil-tight seal is also produced in this exemplary embodiment with the aid of a wall seal 528 that adjoins a smallest outside surface circumference 537 of the connecting element 530 on the damper side and a stationary housing wall 526.

In the drivetrain 601 shown in FIGS. 9, 10 and 11, a connection 622A of a connecting device 622 between a connecting element 623 on the driving side and a connecting element 630 on the damper side is realized without play by means of a simply designed spline connection with a flexing element in the form of an O-ring 650. This O-ring 650 is arranged between a connecting element 623 on the driving side and a connecting element 630 on the damper side in the sense of a friction device, as well as in the sense of a mechanical energy converter.

When the connection 622A is produced, the O-ring is squeezed in such a way that that it is at least partially forced into free spaces 651 (merely numbered in an exemplary fashion in this case) between a form-fitting structure 641 (merely numbered in an exemplary fashion in this case) on the damper side and a form-fitting structure 640 (merely numbered in an exemplary fashion in this case) on the driving side. An assembly clearance that is useful for the assembly but bothersome for an assembled connection 622A, i.e., in the operative state, is prevented in the assembled state of the connection 622A by means of such squeezed O-ring segments 652.

With the exception of the special design of the O-ring 650 of the spline connection 622A, the drivetrain 601 illustrated in FIG. 9 has the design that was already described several times above. In order to avoid repetitions, only the essential components of the drivetrain 601 shown are briefly discussed, namely a crankshaft 606, to which the connecting element 623 on the driving side and a flywheel 607 are screwed by means of a screw arrangement 608. The drivetrain 601 furthermore features a transmission housing 635, on which a stationary housing wall 626 is sealed by means of an outer O-ring seal 634. The stationary housing wall 626 is sealed relative to rotating components such as, e.g., the connecting element 630 on the damper side by means of a wall seal 628 that once again adjoins a smallest outside surface circumference 637 of the connecting element 630 on the damper side. The rotatable components of the drivetrain 601 rotate about a common rotational axis 624.

In order to ensure that the O-ring 650 used in this case remains in its intended position during the assembly in an operationally reliable fashion, the O-ring 650 is inserted into a groove 653 that is recessed into the form-fitting structures 640 on the driving side.

Any play in the circumferential direction of the spline connection 622A is prevented by means of the thusly arranged O-ring 650.

Another exemplary embodiment of an advantageous connection 722A, particularly a spline connection of a connecting device 722, is illustrated in FIGS. 12 to 16. Since the design of the drivetrain 701 is identical to the drivetrains 301, 401 and 601 described above with the exception of the design of the connection 722A, the identical components are no longer discussed in detail. However, these components are included in the list of reference symbols in order to allow an unambiguous identification.

The present connection 722A is realized in the form of a spline connection that is divided into two parts. The spline connection 722A is provided with a first spline gearing 755 and a second spline gearing 756 at least with respect to the form-fitting structures 741 provided on the damper side. In this exemplary embodiment, the form-fitting structures 740 of the spline connection 722A are realized in the form of one-piece structures.

With respect to its form-fitting structures 741 on the damper side, the first spline gearing 755 corresponds to the form-fitting structures 740 of the connecting element 723 on the driving side without additional implements such that free spaces 751 are formed between left-oriented form-fitting structures 741A on the damper side and right-oriented form-fitting structures 740A on the driving side.

In order to fix the form-fitting structures 740 on the driving side and the form-fitting structures 741 on the damper side relative to one another without play, the spline gearing 756 comprises a friction ring 744 and an additional spring arrangement 757.

The spring arrangement 757 ensures that the friction ring 744, the connecting element 723 on the driving side and the connecting element 730 on the damper side are mutually braced. For this purpose, the spring arrangement 757 is supported on the connecting element 730 on the damper side and presses the friction ring 744 with its right-oriented friction ring structures 758 against left-oriented form-fitting structures 740B on the driving side such that a spring element in the form of the spring arrangement 757 is positioned between a friction device in the form of the friction ring 744 and a connecting element 723 on the driving side and a connecting element 730 on the damper side.

The connecting element 723 on the driving side and the connecting element 730 on the damper side are permanently clamped to one another without play by means of this construction.

The spring effect can be suspended, particularly for assembly or disassembly work, until the connecting device 722 was transferred from an assembly position (FIG. 13) into an operative position (FIG. 14). The spring arrangement 757 is not released in order to achieve the corresponding clamping effect until it is in the operative position. The assembly can hereby be significantly simplified because the connection 722A initially can be loosely assembled with a certain play.

The drivetrain 801 illustrated in FIGS. 17 to 19 features another alternative connecting device 822 with clamping elements 860 that can be axially displaced along the common rotational axis 824. The axially displaceable clamping element 860 is realized in the form of a tapered roller In this exemplary embodiment. This tapered roller is supported on a shoulder 845 of a connecting element 823 of the connecting device 822 on the driving side by means of a spring arrangement 857. The connecting element 823 on the driving side features conically designed form-fitting structures 840 on the driving side.

In this exemplary embodiment, the spring arrangement 857 also realizes a spring element that is supported on a shoulder of the connecting element 823, wherein the displaceable clamping element 860 represents a rigid body. The connecting device 822 furthermore features a connecting element 830 on the damper side with form-fitting structures 841 on the damper side that also have a conical design.

A connection 822A without play between components on a driving side 803 and on a transmission side 804 of the drivetrain 801 is produced in that the axially displaceable clamping elements 860 press against the form-fitting structures 840 on the driving side, as well as against the form-fitting structures 841 on the damper side, with the spring force of the spring arrangement 857 and thusly clamp together the connecting element 823 on the driving side and the connecting element 830 on the driven side without play.

A thusly constructed connection 822A also makes it possible to assemble the driving side 803 and the transmission side 804, particularly the connecting element 823 on the driving side and the connecting element 830 of the connecting device 822 on the damper side, with a required assembly clearance. This assembly clearance is only eliminated once the connection 822A is adjusted in a correct operative position. This is achieved when the spring effect of the spring arrangement 857 is activated and the tapered rollers are pressed against the conically extending form-fitting structures 840 on the driving side and the form-fitting structures 841 on the damper side.

FIG. 20 shows a connection 922A that represents an alternative to the connection 822A, but is designed similarly. The connection 922A also features form-fitting structures 940 on the driving side and form-fitting structures 941 on the damper side, all of which are realized conically. The connection 922A also features an axially displaceable clamping element 960 that is realized in the form of a sphere in this exemplary embodiment. The sphere is supported on a shoulder 945 on the connecting element 923 on the driving side by means of a spring arrangement 957 and mutually braces the connecting element 923 on the driving side and the connecting element 930 on the damper side in the operative position shown when the spring arrangement 957 is activated. If the spring effect is reduced or suspended, the connection 922A can also be quite easily separated.

Another advantageous connection between a driving side 1003 and a transmission side 1004 is realized by means of the connection 1022A of a connection 1022 that is illustrated in detail in FIGS. 21 to 25, wherein this connecting device is essentially realized in the form of a dog clutch 1061. The connecting device 1022 furthermore comprises a connecting element 1023 on the driving side that is connected to a connecting element 1030 on the damper side by means of the connection 1022A.

Claws 1062 (see FIG. 23) are provided on the driving side of the connecting element 1023 on the driving side. Accordingly, claws 1063 are provided on the damper side of the connecting element 1030 on the damper side, namely radially offset relative to the claws 1062 on the driving side.

In addition, the connecting device 1022 comprises a retaining ring 1064 that prevents spring-loaded wedges 1065 from carrying out an excessive and therefore undesirable radial excursion referred to the common rotational axis 1024 by means of a spring arrangement 1057 in an assembly position (see FIGS. 22 and 23).

Despite the spring-loaded wedges 1065, this makes it possible to assemble the connecting device 1022 with a certain play and to thusly transfer the connecting element 1023 on the driving side and the connecting element 1030 on the damper side from an assembly position (see FIGS. 22 and 23) into an operative position (see FIGS. 24 and 25).

During the assembly, the retaining ring 1064 is axially displaced along the common rotational axis 1024 in accordance with the direction of the arrow 1066 by means of the connecting element 1030 on the damper side that is pushed on the connecting element 1023 on the driving side, namely until the retaining ring 1064 gives way to the radial tendency of the spring-loaded wedges 1065 such that they ideally are completely displaced into intermediate spaces 1047 between the claws 1062 on the driving side and the claws 1063 on the damper side. The connecting element 1023 on the driving side and the connecting element 1030 on the damper side are thusly clamped together in an operationally reliable fashion. The spring arrangement 1057 in the interior of the retaining ring 1064 also advantageously prevents the wedges 1065 from falling out inward. During the operation, centrifugal forces caused by the rotational movement of the drivetrain 1001 about the common rotational axis 1024 additionally boost the spring effect such that the wedges 1065 always tend to move radially outward and therefore additionally boost the form-fitted connection between the claws 1062 on the driving side and the claws 1063 on the damper side during the operation of the drivetrain 1001.

The spring arrangement 1057 is inwardly supported on a shoulder 1045 of the connecting element 1023 on the driving side. In this case, the wedges 1065 mutually clamp the otherwise exposed form-fitting structures 1040 on the driving side and the form-fitting structures 1041 on the damper side that do not directly interact with one another (see FIG. 25). This embodiment of the connection also can be advantageously separated, particularly when the spring effect of the spring arrangement 1057 is suspended or at least reduced by a suitable amount.

In this embodiment, the wedges 1065 form a rigid body of a force generating means in a form-fitted connection that is effective in the circumferential direction. The spring arrangement 1057 is prestressed in the assembly position by means of the retaining ring 1064 and relieved for the transfer into the installation or operative position, respectively. Consequently, the spring arrangement 1057 should be considered as a transferring means.

In addition to the exemplary embodiments, in which the respectively described connections are realized separably, there also exist inseparable connections that allow a constructively simple connection between a driving side and a transmission side.

For example, a drivetrain 1101 that is illustrated in an exemplary fashion in FIGS. 26 to 31 is provided with a connecting device 1122 that produces a connection 1122A in the form of a simple spline connection with form-fitting structures 1141 on the damper side that are angled relative to form-fitting structures 1140 on the driving side.

In this concrete exemplary embodiment, the form-fitting structures 1140 on the driving side are realized in the form of external teeth on a connecting element 1123 of the connecting device 1122 on the driving side.

The form-fitting structures 1141 on the damper side, in contrast, are realized in the form of angular internal teeth on a connecting element 1130 on the damper side such that the form-fitting structures 1140 on the driving side and the form-fitting structures 1141 on the damper side are mutually wedged when the connecting element 1130 on the damper side is pushed on the connecting element 1123 on the driving side and the connection 1122A is produced in a form-fitting fashion and without play.

The relatively angled form-fitting structures 1140 and 1141 are not only clearly illustrated in FIG. 28, but also in FIGS. 30 and 31. The illustration in FIG. 30 shows a view from the driving side in the direction of the common rotational axis 1124, namely of the connecting element 1123 on the driving side and the connecting element 1130 on the damper side that is interlocked with the former connecting element without play. On the right-oriented form-fitting structures 1140A on the driving side, one can clearly see free spaces 1151 for left-oriented form-fitting structures 1141A on the damper side that are situated opposite thereof.

When observing the connecting elements 1123 and 1130 from the opposite viewing direction, i.e., from the transmission side 1104 (FIG. 31), one can see that the right-oriented form-fitting structures 1140A on the driving side adjoin the left-oriented form-fitting structures 1141A on the damper side in a form-fitted fashion, but additional free spaces 1151A exist between left-oriented form-fitting structures 1140B on the driving side and right-oriented form-fitting structures 1141B on the damper side.

Due to the design of the connection 1122A, a form-fitted connection on the basis of a simply designed spline connection is produced without play. Due to its freedom from play, the spline connection cannot be stressed by driving jerks or driving percussions, particularly on its form-fitting structures 1140 on the driving side and its form-fitting structures 1141 on the damper side. The arrangement without play also prevents an undesirable noise development caused by form-fitting structures 1140, 1141 that loosely adjoin one another.

Another advantageous connection 1222A that makes it possible to connect a driving side 1203 to a transmission side 1204 is realized in a drivetrain 1201 according to FIGS. 32 to 34. A connecting device 1222 comprising the connection 1222A features a connecting element 1223 on the driving side and a connecting element 1230 on the damper side, wherein the connection 1222A is realized with these connecting elements.

In the operative position illustrated in FIG. 32, freedom from play in the connection 1222A is ensured in that spring clips 1267 provided on the connecting element 1230 on the damper side and projections 1268 provided on the connecting element 1223 on the driving side are joined together. In this exemplary embodiment of the drivetrain 1201, the projections 1268 are realized in the form of cams of the connecting element 1223 on the driving side that are aligned radially referred to a common rotational axis 1224.

FIG. 33 shows the transfer of an exemplary spring clip 1267 from an assembly position (upper arrangement) into an operative position (lower arrangement). In the assembly position, the spring clip 1267 is positioned in front of the projection 1268.

If the connecting element 1230 on the damper side is now pushed on the connecting element 1223 on the driving side and the connection 1222A is produced, the projection 1268 is pushed into the widening spring clip 1267. Once the two connecting elements 1223, 1230 are pushed into one another up to the operative position and aligned, the projection 1268 in the spring clip 1267 reaches a holding position, in which the spring clip 1267 that was previously widened by the projection 1268 closes again.

In order to ensure that the projections 1268 do not widen the spring clips 1267, a spring clip safety 1269 is pushed on the spring clip 1267 in this exemplary embodiment, wherein it is also possible to forgo such a spring clip safety, if applicable. However, a dilation of the spring clip 1267 is thusly prevented in an operationally reliable fashion. The spring clip safeties additionally reinforce the arrangement between the spring clip 1267 and the projection 1268.

Due to the connection 1222A, a connection 1222A without play is also realized in a constructively simple fashion between components arranged on the driving side and components of a drivetrain 1201 arranged on the damper or transmission side, respectively.

### LIST OF REFERENCE SYMBOLS

1 Drivetrain
2 Transition area
3 Driving side
4 Transmission side
5 Primary housing part
6 Crankshaft
7 Flywheel
8 Screw arrangement
9 Outside circumference
10 Gear rim
11 Secondary housing part
12 Housing screw arrangement
13 Dual clutch
14 Clutch output shaft
15 Clutch output sleeve
16 Torsional vibration damper
17 Torsional vibration damper input side
18 Torsional vibration damper output side
19 Torsional vibration damper springs
20 Driven torsional vibration damper section
21 Driving torsional vibration damper section
22 Connecting device
22A Connection
23 Connecting element on driving side
24 Common rotational axis
25 Oil chamber
26 Stationary housing wall
27 Rotating housing wall
28 Wall seal
101 Drivetrain
102 Transition area
103 Driven side
104 Transmission side
106 Crankshaft
107 Flywheel
108 Screw arrangement
110 Gear rim
113 Dual clutch
114 Clutch output shaft
115 Clutch output sleeve
116 Torsional vibration damper
117 Torsional vibration damper input side
118 Torsional vibration damper output side
119 Torsional vibration damper springs
120 Driven torsional vibration damper section
121 Driving torsional vibration damper section
122 Connecting device
122A Connection
123 Connecting element on driving side
124 Common rotational axis
125 Oil chamber
126 Stationary housing wall
128 Seal
130 Connecting element on damper side
131 Centering surface
132 Connecting plate
133 Sleeve-screw arrangement
134 O-ring seal
135 Transmission housing
201 Drivetrain
202 Transition area
203 Driving side
204 Transmission side
206 Crankshaft
207 Flywheel
208 Screw arrangement
210 Gear rim
213 Dual clutch
214 Clutch output shaft
215 Clutch output sleeve
216 Torsional vibration damper
218 Torsional vibration damper output side
219 Torsional vibration damper springs
220 Driven torsional vibration damper section
221 Driving torsional vibration damper section
222 Connecting device
222A Connection
224 Common rotational axis
225 Oil chamber
226 Stationary housing wall
228 Seal
230 Connecting element on damper side
234 O-ring seal
235 Transmission housing
236 Flywheel web
301 Drivetrain
302 Transition area
303 Driven side
304 Transmission side
306 Crankshaft
307 Flywheel
308 Screw arrangement
313 Dual clutch
314 Clutch output shaft
315 Clutch output sleeve
316 Torsional vibration damper
317 Torsional vibration damper input side
318 Torsional vibration damper output side
319 Torsional vibration damper springs
320 Driven torsional vibration damper section
321 Driving torsional vibration damper section
322A Connection
323 Connecting element on driving side
324 Common rotational axis
325 Oil chamber
326 Stationary housing wall
328 Seal
334 O-ring seal
335 Transmission housing
337 Smallest outside surface circumference
401 Drivetrain
403 Driven side
404 Transmission side
406 Crankshaft
407 Flywheel
408 Screw arrangement
410 Gear rim
416 Torsional vibration damper
417 Torsional vibration damper input side
418 Torsional vibration damper output side
419 Torsional vibration damper springs
421 Driving torsional vibration damper section
422 Connecting device
422A Connection
423 Connecting element on driving side
424 Common rotational axis
426 Stationary housing wall
427 Rotating housing wall
428 Seal
430 Connecting element on damper side
434 O-ring seal
435 Transmission housing
437 Smallest outside surface circumference
440 Form-fitting structures on driving side
441 Form-fitting structures on damper side
442 Outside surface
443 Inner side
444 Friction ring
445 Shoulder
446 Wedge-shaped elevation
447 Intermediate spaces
448 Teeth
522 Connecting device
522A Connection
523 Connecting element on driving side
526 Stationary housing wall
528 Seal
530 Connecting element on damper side
537 Smallest outside surface circumference
540 Form-fitting structures on driving side
541 Form-fitting structures on damper side
544 Friction ring
601 Drivetrain
603 Driving side
604 Transmission side
606 Crankshaft
607 Flywheel
608 Screw arrangement
610 Gear rim
616 Torsional vibration damper
618 Torsional vibration damper output side
619 Torsional vibration damper springs
621 Driving torsional vibration damper section
622 Connecting device
622A Connection
623 Connecting element on driving side
624 Common rotational axis
627 Rotating housing wall
628 Seal
630 Connecting element on damper side
634 O-ring seal
635 Transmission housing
637 Smallest outside surface circumference
640 Form-fitting structures on driving side
641 Form-fitting structures on damper side
650 O-ring
651 Free space is
652 Squeezed O-ring segments
653 Recessed groove
701 Drivetrain
703 Driven side
704 Transmission side
706 Crankshaft
707 Flywheel
708 Screw arrangement
710 Gear rim
716 Torsional vibration damper
717 Torsional vibration damper input side
718 Torsional vibration damper output side
719 Torsional vibration damper springs
721 Driving torsional vibration damper section
722 Connecting device
722A Connection
723 Connecting element on driving side
724 Common rotational axis
726 Stationary housing wall
727 Rotating housing wall
728 Seal
730 Connecting element on damper side
734 O-ring seal
735 Transmission housing
740 Form-fitting structures on driving side
740A Right-oriented form-fitting structures on
740B driving side
740B Left-oriented form-fitting structures on driving side
741 Form-fitting structures on damper side
741A Left-oriented form-fitting structures on damper side
744 Friction ring
751 Free spaces
755 Spline gearing
756 Second spline gearing
757 Spring arrangement
758 Right-oriented friction ring structures
801 Drivetrain
803 Driving side
804 Transmission side
806 Crankshaft
807 Flywheel
808 Screw arrangement
810 Gear rim
816 Torsional vibration damper
817 Torsional vibration damper input side
818 Torsional vibration damper output side
819 Torsional vibration damper springs
821 Driving torsional vibration damper section
822 Connecting device
822A Connection
823 Connecting element on driving side
824 Common rotational axis
826 Stationary housing wall
827 Rotating housing wall
828 Seal
830 Connecting element on damper side
834 O-ring seal
835 Transmission housing
840 Form-fitting structures on driving side
841 Form-fitting structures on damper side
845 Shoulder
857 Spring arrangement
860 Axially displaceable clamping element
907 Flywheel
922 Connecting device
922A Connection
923 Connecting element on driving side
926 Stationary housing wall
928 Seal
930 Connecting element on damper side
940 Form-fitting structures on driving side
941 Form-fitting structures on damper side
945 Shoulder
957 Spring arrangement
960 Axially displaceable clamping element
1001 Drivetrain
1003 Driven side
1004 Transmission side
1006 Crankshaft
1007 Flywheel
1008 Screw arrangement
1010 Gear rim
1016 Torsional vibration damper
1017 Torsional vibration damper input side
1018 Torsional vibration damper output side
1019 Torsional vibration damper springs
1021 Driving torsional vibration damper section
1022 Connecting device
1022A Connection
1023 Connecting element on driving side
1024 Common rotational axis
1026 Stationary housing wall
1027 Rotating housing wall
1028 Seal
1030 Connecting element on damper side
1034 O-ring seal
1035 Transmission housing
1040 Form-fitting structures on driving side
1041 Form-fitting structures on damper side
1045 Shoulder
1047 Intermediate spaces
1057 spring arrangement
1061 Dog clutch
1062 Claws on driving side
1063 Claws on damper side
1064 Retaining ring
1065 Spring-loaded wedges
1066 Direction of arrow
1101 Drivetrain
1103 Driven side
1104 Transmission side
1106 Crankshaft
1107 Flywheel
1108 Screw arrangement
1110 Gear rim
1116 Torsional vibration damper
1117 Torsional vibration damper input side
1118 Torsional vibration damper output side
1119 Torsional vibration damper springs
1121 Driving torsional vibration damper section
1122 Connecting device
1122A Connection
1123 Connecting element on driving side
1124 Common rotational axis
1126 Stationary housing wall
1127 Rotating housing wall
1128 Seal
1130 Connecting element on damper side
1140 Form-fitting structures on driving side
1140A Right-oriented form-fitting structures on driving side
1140B Left-oriented form-fitting structures on driving side
1141 Form-fitting structures on damper side
1141A Right-oriented form-fitting structures on damper side
1141B Left-oriented form-fitting structures on damper side
1151 Free spaces
1151A Additional free spaces
1201 Drivetrain
1203 Driven side
1204 Transmission side
1206 Crankshaft
1207 Flywheel
1208 Screw arrangement
1210 Gear rim
1216 Torsional vibration damper
1217 Torsional vibration damper input side
1218 Torsional vibration damper output side
1219 Torsional vibration damper springs
1221 Driving torsional vibration damper section
1222 Connecting device
1222A Connection
1223 Connecting element on driving side
1224 Common rotational axis
1226 Stationary housing wall
1227 Rotating housing wall
1228 Seal
1230 Connecting element on damper side
1234 O-ring seal
1235 Transmission housing
1267 Spring clip
1268 Projection
1269 Spring clip safety

1. A drivetrain with a main drive shaft and a torsional vibration damper, wherein the main drive shaft and the torsional vibration damper essentially rotate about a common rotational axis and are connected to one another by means of a connection, wherein the connection can be separated in an indestructible fashion and/or is self-connecting, and wherein a wall is arranged axially between the main drive shaft and the torsional vibration damper and sealed at the drivetrain by means of a seal, wherein the connection is arranged at a greater radial distance from the common rotational axis than the seal and than the main drive shaft in the region of the seal.

2. A drivetrain with a main drive shaft and with a torsional vibration damper according to claim 1, wherein the main drive shaft and the torsional vibration damper are connected to one another by means of a connection that can be separated in a nondestructive fashion and/or is self-connecting and rotate about a common rotational axis, and with a wall that is arranged between the main drive shaft and the torsional vibration damper and sealed at the drivetrain by means of a seal, wherein the seal is arranged axially on the driving side referred to the connection.

3. A drivetrain with a main drive shaft and with a torsional vibration damper according to claim 1, wherein the main drive shaft and the torsional vibration damper are connected to one another by means of a connection that can be separated in a nondestructive fashion and/or is self-connecting and rotate about a common rotational axis, and with a wall that is arranged between the main drive shaft and the torsional vibration damper and sealed at the drivetrain by means of a seal, wherein the seal is arranged axially on the transmission side referred to the connection.

4. The drivetrain according to claim 1, comprising a flywheel (7) that is rigidly arranged on the main drive shaft (6) on the driving side of the connection.

5. The drivetrain according to claim 4, wherein a component (flywheel web 236) of the flywheel (207) forms part of the connection (222A) on the driving side.

6. The drivetrain according to claim 1, comprising a connecting element (130) of the connection (122A) on the damper side that is adjoined by the seal (128) on the damper side of the connection (122A).

7. The drivetrain according to claim 1, wherein the connection (22A) comprises a connecting element (23) on the driving side that is rigidly connected to a flywheel (7) and/or the main drive shaft (8) on the driving side and is adjoined by the seal (28) on the driving side of the connection (22A).

8. The drivetrain according to claim 7, wherein the connection (22A) is arranged on a larger circumference than the seal (28) on the driven side of the seal.

9. The drivetrain according to claim 7, wherein the connection (22A) is arranged in an oil chamber (25).

10. The drivetrain according to claim 1, comprising a gear rim (10) that is fixed on the outer edge (9) of a flywheel (7) radially referred to the common rotational axis (24)

11. A drivetrain for a motor vehicle with a drive shaft according to claim 1, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the connecting plate is connected in a nondestructively separable fashion to a rigid driving wheel radially outward on the driving side.

12. A drivetrain for a motor vehicle with a drive shaft according to claim 1, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the connection between the damper shaft and the connecting plate comprises a press-fitted connection between a connection group on the damper side and a connection group on the connecting plate side.

13. A drivetrain for a motor vehicle with a drive shaft according to claim 1, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the connection between the damper shaft and the connecting plate comprises an axial friction-fitted connection between a connection group on the damper side and a connection group on the connecting plate side.

14. A drivetrain for a motor vehicle with a drive shaft to claim 1, with a transmission on the driven side and with a clutch arranged between the drive shaft and the transmission, as well as with a vibration damper that is arranged on the driving side of the clutch and features on the driving side a damper shaft that is functionally connected to the drive shaft by means of a connecting plate, wherein the connection between the damper shaft and the connecting plate comprises a cylindrical connecting region between a connection group on the damper side and a connection group on the connecting plate side.

15. A drivetrain for a motor vehicle with a drive shaft, with a transmission on the driven side and with a clutch arranged between the drive shaft and the transmission, as well as with a torsional vibration damper that is arranged on the driving side of the clutch and features on the driving side a damper shaft that is connected to the drive shaft by means of a form-fitted connection that is effective in the second circumferential direction and comprises at least two form-fitting structures on the drive shaft side and at least two form-fitting structures on the damper shaft side, wherein one of the form-fitting structures on the driving side and one of the form-fitting structures on the damper shaft side respectively point in a first circumferential direction and the second form-fitting structure on the driving side and the second form-fitting structure on the damper shaft side respectively point in the second circumferential direction, wherein the form-fitting structure of the form-fitting structures on the driving side that points in the first circumferential direction interacts with the form-fitting structure of the form-fitting structures on the damper shaft side that points in the second circumferential direction and the form-fitting structure of the form-fitting structures on the driving side that points in the second circumferential direction interacts with the form-fitting structure of the form-fitting structures on the damper shaft side that points in the first circumferential direction, wherein the drivetrain has an operating state, in which torque is transmitted to the form-fitting structure of the form-fitting structures on the damper shaft side that points in the second circumferential direction by the form-fitting structure of the form-fitting structures on the driving side that points in the first circumferential direction and in which the form-fitting structure of the form-fitting structures on the driving side that points in the second circumferential direction is spaced apart from the form-fitting structure of the form-fitting structures on the damper shaft side that points in the first circumferential direction by a certain clearance, comprising means for generating a force that is not dependent on the angle of twist between the drive shaft and the damper shaft and counteracts a reduction of the clearance.

16. The drivetrain according to claim 15, wherein the force generating means comprise a mechanical energy converter for converting mechanical energy into thermal energy.

17. The drivetrain according to claim 16, wherein the mechanical energy converter is connected to the drive shaft (406) and/or to the damper shaft (430) by means of a form-fitted connection.

18. The drivetrain according to claim 16, wherein the mechanical energy converter comprises a friction device.

19. The drivetrain according to claim 18, wherein the friction device consists of a friction ring (444).

20. The drivetrain according to claim 18, wherein the friction device is effective in the axial direction.

21. The drivetrain according to claim 18, wherein a spring element (757) is arranged between the friction device (744) and the drive shaft (723) and/or the damper shaft (730).

22. The drivetrain according to claim 18, wherein the friction device comprises a flexing element.

23. The drivetrain according to claim 16, wherein the mechanical energy converter comprises a flexing element.

24. The drivetrain according to claim 23, wherein the flexing element (650) is arranged between a structure (640) on the driving side that is effective in the circumferential direction and a structure (641) on the damper shaft side that is effective in the circumferential direction.

25. The drivetrain according to claim 22, wherein the flexing element (650) is realized in the form of an elastic rubber element.

26. The drivetrain according to claim 15, wherein the force generating means comprise a rigid body (1065).

27. A drivetrain for a motor vehicle according to claim 1 with a drive shaft that extends out of an engine block, with a transmission on the driven side and with a clutch that is arranged between the drive shaft and the transmission, as well as with a vibration damper that is arranged on the driving side of the clutch, wherein said vibration damper is arranged in an oil-tight housing and features on the driving side a damper shaft that is connected to the drive shaft by means of a friction-fitted connection that is effective in the circumferential direction, comprising a rigid body in the form-fitted connection that is effective in the circumferential direction.

28. The drivetrain according to claim 26, wherein the rigid body (1065) has an assembly position and an installation position, and wherein means are provided that transfer the rigid body (1065) from the assembly position into the installation position during the assembly.

29. The drivetrain according to claim 28, wherein the transferring means comprise a spring element (757).

30. The drivetrain according to claim 29, wherein the spring element (757) is prestressed in the assembly position and relieved for the transfer into the installation position.

31. The drivetrain according to claim 15, wherein the form-fitted connection is axially produced by means of devices that are rigidly connected to the housing or the engine block, respectively.

32. The drivetrain according to claim 15, wherein a spring element (757) is arranged between the drive shaft (723) and the damper shaft (730)

33. The drivetrain according to claim 15, wherein the damper shaft (23) penetrates a wall (26) of the oil-tight housing (11) and is connected to the drive shaft (6) outside the housing (11).

34. The drivetrain according to claim 15, wherein the clutch consists of a dual clutch (13).

35. The drivetrain according to claim 15, wherein the clutch consists of a converter clutch.

36. The drivetrain according to claim 1, wherein the drive shaft (6) extends out of an engine block (5).

37. The drivetrain according to claim 1, wherein the vibration damper (16) is arranged in an oil-tight housing (25)
